(19) United States
(12) Patent Application Publication
(10) Pub. No.: US 2026/0193104 A1
(43) Pub. Date: Jul. 9, 2026

(54) REUSABLE WATER FILTER CARTRIDGE

(71) Applicant: ELECTROLUX HOME PRODUCTS, INC., Charlotte, NC (US)

(72) Inventors: Thomas W. MCCOLLOUGH, Anderson, SC (US); Zhuochen SHI, Clemson, SC (US)

(73) Assignee: ELECTROLUX HOME PRODUCTS, INC., Charlotte, NC (US)

(21) Appl. No.: 19/128,789

(22) PCT Filed: Nov. 9, 2023
(86) PCT No.: PCT/US2023/079242

§ 371 Date: May 9, 2025

Related U.S. Application Data
(60) Provisional application No. 63/423,971, filed on Nov. 9, 2022.
(60) Provisional application No. 63/541,316, filed on Sep. 29, 2023.

(51) Int. Cl. C02F 1/00; C02F 103/02

(52) U.S. Cl. CPC C02F 1/003; C02F 2103/02; C02F 2201/004; C02F 2201/006; C02F 2201/007; C02F 2307/12

(57) ABSTRACT

A reusable water filter cartridge is described herein. The water filter cartridge may include a filter housing defining a cavity. The water filter cartridge may include a fluid inlet and a fluid outlet positioned on the filter housing and in fluid communication with the cavity. The water filter cartridge may include a removable filtration media positioned within the cavity, wherein the filter housing is configured to provide access to the removable filtration media.

### CROSS-REFERENCE TO RELATED APPLICATIONS

The present application claims priority to and benefit from U.S. Provisional Patent Application No. 63/423,971, filed Nov. 9, 2022, and U.S. Provisional Patent Application No. 63/541,316, filed Sep. 29, 2023. Each of the foregoing patent applications is hereby incorporated by reference in its entirety.

### FIELD OF THE INVENTION

The present invention embraces a reusable water filter cartridge, such as a water filter in an appliance (e.g., a refrigerator, a freezer, and/or the like).

### BACKGROUND

Appliances, such as refrigerators, freezers, and/or the like, may include one or more components, such as a water dispenser, an ice maker, and/or the like, which use water from a water supply (e.g., a household water supply and/or the like). Such appliances typically include a water filter that filters water received from the water supply before the water is provided to the one or more components. Such water filters have a useful lifespan that is shorter than the appliance and must be replaced for the appliance to continue to provide properly filtered water. Appliances typically include an opening to permit a user to remove an expired water filter and install a replacement water filter. However, water filters are comprised of multiple components, all of which are discarded when the water filter is discarded, thus leading to excessive environmental waste.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. This summary presents some concepts of one or more embodiments of the present invention in a simplified form as a prelude to the more detailed description that is presented later.

In one aspect, the present invention embraces a water filter cartridge. The water filter cartridge may include a filter housing defining a cavity, a fluid inlet and a fluid outlet positioned on the filter housing and in fluid communication with the cavity, and a removable filtration media positioned within the cavity, wherein the filter housing may be configured to provide access to the removable filtration media.

In some embodiments, the filter housing has a first end, a second end, and a longitudinal axis. The fluid inlet and the fluid outlet may be positioned at the first end, and the filter housing may be configured to provide the access to the removable filtration media at the first end.

In some embodiments, the filter housing may include a cross-over passage in fluid communication with the fluid outlet and the removable filtration media.

In some embodiments, the removable filtration media may include a cross-over passage in fluid communication with the fluid outlet.

In some embodiments, the water filter cartridge may include a filtration media unit including the removable filtration media.

In some embodiments, the fluid inlet and the fluid outlet may be configured to engage a manifold of an appliance, and the water filter cartridge may be configured to be removable from the appliance.

In some embodiments, the filter housing may include a removable portion configured to be removed from another portion of the filter housing to provide the access to the removable filtration media.

In some embodiments, the removable portion may be a cap configured to engage the filter housing and seal the cavity, and the cap may be configured to be manually removable from the other portion of the filter housing to provide the access to the removable filtration media.

In some embodiments, the cap may be configured to be manually replaced to seal the cavity.

In some embodiments, the removable portion may be a filter head including the fluid inlet and the fluid outlet, wherein the filter head may be configured to be manually removable from the other portion of the filter housing to provide the access to the removable filtration media.

In some embodiments, the removable portion may be a filter head including the fluid inlet and the fluid outlet, and the filter head may be fixed to the removable filtration media such that when the filter head may be removed from the other portion of the filter housing the removable filtration media may be removed from the filter housing as a result.

In some embodiments, the filter head may include a key extending radially outward from the filter head and at least one displaceable latch feature extending longitudinally from the filter head.

In some embodiments, after insertion of the water filter cartridge into a manifold including at least one receptacle, a stop element of the at least one receptacle interacts with the at least one displaceable latch feature to prevent rotation of the water filter cartridge in a first direction, and after insertion of the water filter cartridge into the manifold, a curved transition surface of the manifold interacts with the at least one displaceable latch feature to permit rotation of the water filter cartridge in a second direction.

In some embodiments, during insertion of the water filter cartridge into a manifold, a latch feature of the at least one displaceable latch feature interacts with a curved interior surface of the manifold, prior to being received by at least one receptacle of the manifold, to force the at least one displaceable latch feature to flex radially inward as a result.

In some embodiments, during removal of the water filter cartridge from a manifold, and counterclockwise rotation of the water filter cartridge in the manifold, the at least one displaceable latch feature interacts with a curved transition surface of at least one receptacle of the manifold to force the at least one displaceable latch feature to flex radially inward.

In another aspect, the present invention embraces a filtration media unit. The filtration media unit may include filtration media, and an interface mechanism for providing fluid communication between a fluid inlet of a filter cartridge and the filtration media and the filtration media and a fluid outlet of the filter cartridge, and the interface mechanism may be configured to be detachable from the filter cartridge.

In some embodiments, the filtration media has a first end, a second end, and a longitudinal axis, and the interface mechanism may be positioned on the first end of the filtration media.

In some embodiments, the interface mechanism may include a cross-over passage to provide the fluid communication between the filtration media and the fluid outlet of the filter cartridge.

In some embodiments, the interface mechanism may include a key extending radially outward from the interface mechanism, and at least one displaceable latch feature extending longitudinally from the interface mechanism.

In some embodiments, after insertion of the filtration media unit into a manifold including at least one receptacle, a stop element of the at least one receptacle interacts with the at least one displaceable latch feature to prevent rotation of the filtration media unit in a first direction, and after insertion of the filtration media unit into the manifold, a curved transition surface of the manifold interacts with the at least one displaceable latch feature to permit rotation of the filtration media unit in a second direction.

In some embodiments, during insertion of the filtration media unit into a manifold, a latch feature of the at least one displaceable latch feature interacts with a curved interior surface of the manifold, prior to being received by the at least one receptacle of the manifold, to force the at least one displaceable latch feature to flex radially inward as a result.

In some embodiments, during removal of the filtration media unit from the manifold, and counterclockwise rotation of the filtration media unit in the manifold, the at least one displaceable latch feature interacts with a curved transition surface of the at least one receptacle of the manifold to force the at least one displaceable latch feature to flex radially inward.

In yet another aspect, the present invention embraces a method of replacing filtration media within a water filter cartridge. The method may include providing a water filter cartridge, including a filter housing defining a cavity, a fluid inlet and a fluid outlet positioned on the filter housing and in fluid communication with the cavity, and a first removable filtration media positioned within the cavity. The filter housing may be configured to provide access to the first removable filtration media. The method may further include manipulating the filter housing to obtain the access to the first removable filtration media, removing the first removable filtration media from the cavity, inserting a second removable filtration media into the cavity, and manipulating the filter housing to seal the cavity.

In some embodiments, the water filter cartridge may be the water filter cartridge of any one of the previous embodiments.

In yet another aspect, the present invention embraces a water filter cartridge. The water filter cartridge may include a filter housing a having a first end, a second end, and a longitudinal axis, wherein the filter housing defines a cavity, and wherein the first end may include connecting means for operably coupling with a manifold of an appliance, a fluid inlet and a fluid outlet at the first end of the filter housing, and a removable filtration media positioned within the cavity. The filter housing may be configured to provide access to the removable filtration media.

In some embodiments, the removable filtration media may be configured to be manually removed from the cavity.

In some embodiments, the filter housing may include a cross-over passage in fluid communication with the fluid outlet and the removable filtration media.

In some embodiments, the removable filtration media may include a cross-over passage in fluid communication with the fluid outlet.

In some embodiments, the water filter cartridge may include a filtration media unit including the removable filtration media.

In some embodiments, the fluid inlet and the fluid outlet are configured to engage a manifold of an appliance, and the water filter cartridge may be configured to be removable from the appliance.

In some embodiments, the filter housing may include a removable portion configured to be removed from another portion of the filter housing to provide the access to the removable filtration media.

In some embodiments, the removable portion may be a cap configured to engage the filter housing and seal the cavity, wherein the cap may be configured to be manually removable from the other portion of the filter housing to provide the access to the removable filtration media.

In some embodiments, the cap may be configured to be manually replaced to seal the cavity.

In some embodiments, the removable portion may be a filter head including the fluid inlet and the fluid outlet, wherein the filter head may be configured to be manually removable from the other portion of the filter housing to provide the access to the removable filtration media.

In some embodiments, the removable portion may be a filter head including the fluid inlet and the fluid outlet, and the filter head may be fixed to the removable filtration media such that when the filter head may be removed from the other portion of the filter housing the removable filtration media may be removed from the filter housing as a result.

In some embodiments, the filter head may include a key extending radially outward from the filter head and at least one displaceable latch feature extending longitudinally from the filter head.

In some embodiments, after insertion of the water filter cartridge into a manifold including at least one receptacle, a stop element of the at least one receptacle interacts with the at least one displaceable latch feature to prevent rotation of the water filter cartridge in a first direction. After insertion of the water filter cartridge into the manifold, a curved transition surface of the manifold interacts with the at least one displaceable latch feature to permit rotation of the water filter cartridge in a second direction.

In some embodiments, during insertion of the water filter cartridge into the manifold, a latch feature of the at least one displaceable latch feature interacts with a curved interior surface of the manifold, prior to being received by the at least one receptacle of the manifold, to force the at least one displaceable latch feature to flex radially inward as a result.

In some embodiments, during removal of the water filter cartridge from the manifold, and counterclockwise rotation of the water filter cartridge in the manifold, the at least one displaceable latch feature interacts with the curved transition surface of the at least one receptacle of the manifold to force the at least one displaceable latch feature to flex radially inward.

The features, functions, and advantages that have been discussed may be achieved independently in various embodiments of the present invention or may be combined with yet other embodiments, further details of which may be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates a perspective view of a water filter cartridge, in accordance with an embodiment of the invention;

FIG. 2 illustrates a cross-sectional perspective view of a water filter cartridge, in accordance with an embodiment of the invention;

FIG. 3A illustrates a perspective view of an interface mechanism, in accordance with an embodiment of the invention;

FIG. 3B illustrates a perspective view of an interface mechanism, in accordance with an embodiment of the invention;

FIG. 3C illustrates a perspective view of an endcap, in accordance with an embodiment of the invention;

FIG. 4 illustrates a cross-sectional perspective view of a water filter cartridge, in accordance with an embodiment of the invention;

FIG. 5A illustrates a perspective view of an interface mechanism, in accordance with an embodiment of the invention;

FIG. 5B illustrates a perspective view of an interface mechanism, in accordance with an embodiment of the invention;

FIG. 6 illustrates a side view of a water filter cartridge including a head, in accordance with an embodiment of the invention;

FIG. 7 illustrates a side view of a water filter cartridge including a head, in accordance with an embodiment of the invention;

FIG. 8 illustrates a partial cross-sectional view of a water filter cartridge including a head, in accordance with an embodiment of the invention;

FIG. 9 illustrates a perspective view of a water filter cartridge including a head, in accordance with an embodiment of the invention;

FIG. 9A illustrates a perspective view of a head, in accordance with the embodiment of FIG. 9;

FIG. 9B illustrates a perspective view of a head, in accordance with an embodiment of FIG. 9;

FIG. 10 illustrates a partial cross-sectional view of a water filter cartridge including a head, in accordance with an embodiment of the invention;

FIG. 10A illustrates a perspective view of a head, in accordance with the embodiment of FIG. 10;

FIG. 10B illustrates a perspective view of a head, in accordance with the embodiment of FIG. 10;

FIG. 11A illustrates a rear view of a head, in accordance with an embodiment of the invention;

FIG. 11B illustrates a side view of a head, in accordance with an embodiment of the invention;

FIG. 11C illustrates a top plan view of a head, in accordance with an embodiment of the invention;

FIG. 11D illustrates a top plan view of a head, in accordance with an embodiment of the invention;

FIG. 12A illustrates a perspective view of a head, in accordance with an embodiment of the invention;

FIG. 12B illustrates a perspective view of a head, in accordance with an embodiment of the invention;

FIG. 12C illustrates a cross-sectional view of a head, in accordance with an embodiment of the invention;

FIG. 13 illustrates a perspective view of a water filter cartridge including a head, in accordance with an embodiment of the invention;

FIG. 13A illustrates a cross-sectional view of a water filter cartridge, in accordance with the embodiment of FIG. 13;

FIG. 13B illustrates a side view of a water filter cartridge including a head, in accordance with an embodiment of the invention;

FIG. 14 illustrates a side view of a water filter cartridge including a head, in accordance with an embodiment of the invention;

FIG. 14A illustrates a side view of the head, in accordance with the embodiment of FIG. 14;

FIG. 14B illustrates another side view of the head, in accordance with the embodiment of FIG. 14;

FIG. 15 illustrates a perspective view of a head, in accordance with an embodiment of the invention;

FIG. 16 illustrates a perspective view of a head, in accordance with the embodiment of FIG. 15;

FIG. 16B illustrates a perspective view of a head, in accordance with an embodiment of the invention;

FIG. 17 illustrates a perspective view of a head, in accordance with an embodiment of the invention;

FIG. 18 illustrates a perspective view of a head, in accordance with an embodiment of the invention;

FIG. 19 illustrates a perspective view of a head, in accordance with an embodiment of the invention;

FIG. 20 illustrates a perspective view of a head, in accordance with an embodiment of the invention;

FIG. 21 illustrates a perspective view of a head, in accordance with an embodiment of the invention;

FIG. 22 illustrates a perspective view of a head, in accordance with an embodiment of the invention;

FIG. 23 illustrates a perspective view of a head, in accordance with an embodiment of the invention;

FIG. 24 illustrates a perspective view of a head, in accordance with an embodiment of the invention;

FIG. 25 illustrates an exploded view of a water filter cartridge, in accordance with an embodiment of the invention;

FIG. 26 illustrates a perspective view of a head, in accordance with an embodiment of the invention;

FIG. 27 illustrates a perspective view of a head, in accordance with an embodiment of the invention;

FIG. 28 illustrates a perspective view of a water filter cartridge, in accordance with an embodiment of the invention;

FIG. 29 illustrates cross-sectional perspective view of a water filter cartridge, in accordance with an embodiment of the invention;

FIG. 30 illustrates a perspective view of a water filter cartridge, in accordance with an embodiment of the invention;

FIG. 31 illustrates a perspective view of a spring, in accordance with an embodiment of the invention;

FIG. 32 illustrates a perspective view of a water filter cartridge, in accordance with an embodiment of the invention;

FIG. 33 illustrates a perspective view of a head, in accordance with an embodiment of the invention;

FIG. 34 illustrates a perspective view of a head, in accordance with the embodiment of FIG. 33;

FIG. 35 illustrates a perspective view of a head, in accordance with the embodiment of FIG. 33; and

FIG. 36 illustrates a front view of a head, in accordance with the embodiment of FIG. 33.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout. Where possible, any of the advantages, features, functions, devices, and/or operational aspects of any of the embodiments of the present invention described and/or contemplated herein may be included in any of the other embodiments of the present invention described and/or contemplated herein, and/or vice versa.

As used herein, “operatively coupled” may mean that the components may be formed integrally with each other or may be formed separately and coupled together. Furthermore, “operatively coupled” may mean that the components may be formed directly to each other or to each other with one or more components located between the components that are operatively coupled together. Additionally, or alternatively, “operatively coupled” may mean that the components are detachable from each other or that they are permanently coupled together. Furthermore, “operatively coupled” components may mean that the components retain at least some freedom of movement in one or more directions or may be rotated about an axis (i.e., rotationally coupled, pivotally coupled, and/or the like).

As noted, appliances, such as refrigerators, freezers, and/or the like, may include one or more components, such as a water dispenser, an ice maker, and/or the like, which use water from a water supply (e.g., a household water supply and/or the like). Such appliances typically include a water filter that filters water received from the water supply before the water is provided to the one or more components. Such water filters have a useful lifespan that is shorter than the appliance and must be replaced for the appliance to continue to provide properly filtered water. Appliances typically include an opening to permit a user to remove an expired water filter and install a replacement water filter. However, water filters are comprised of multiple components, many of which may be reused if the user were able to properly access and replace the consumable portions of the water filter, such as the filtration media. By allowing access to the internal components of the water filter so that a user can replace the filtration media, and thereafter reuse the remaining components of the water filter, environmental waste and costs to the consumer are reduced.

Some embodiments described herein provide a mechanical interlock system for a filter, such as a water filter, which may be included in an appliance. In some embodiments, the mechanical interlock system may include a filter cartridge and a filter cartridge manifold for an appliance push-to-lock mechanism for securing the filter cartridge and a twist-to-unlock mechanism for releasing the filter cartridge.

In one aspect, the present invention embraces a water filter cartridge. The water filter cartridge may include a filter housing defining a cavity, a fluid inlet and a fluid outlet positioned on the filter housing and in fluid communication with the cavity, and a removable filtration media positioned within the cavity. The filter housing may be configured to provide access to the removable filtration media.

The water filter cartridge may include additional embodiments, such as any single embodiment or any combination of embodiments described below and/or in connection with one or more other water filter cartridges described elsewhere herein.

In a first embodiment, the filter housing has a first end, a second end, and a longitudinal axis. The fluid inlet and the fluid outlet may be positioned at the first end, and the filter housing may be configured to provide the access to the removable filtration media at the first end.

In a second embodiment, alone or in combination with one or more of the first and second embodiments, the filter housing may include a cross-over passage in fluid communication with the fluid outlet and the removable filtration media.

In a third embodiment, alone or in combination with one or more of the first through third embodiments, the removable filtration media may include a cross-over passage in fluid communication with the fluid outlet.

In a fourth embodiment, alone or in combination with one or more of the first through fourth embodiments, the water filter cartridge may include a filtration media unit including the removable filtration media.

In a fifth embodiment, alone or in combination with one or more of the first through fifth embodiments, the fluid inlet and the fluid outlet may be configured to engage a manifold of an appliance, and the water filter cartridge may be configured to be removable from the appliance.

In a sixth embodiment, alone or in combination with one or more of the first through sixth embodiments, the filter housing may include a removable portion configured to be removed from another portion of the filter housing to provide the access to the removable filtration media.

In a seventh embodiment, alone or in combination with one or more of the first through seventh embodiments, the removable portion may be a cap configured to engage the filter housing and seal the cavity, and the cap may be configured to be manually removable from the other portion of the filter housing to provide the access to the removable filtration media.

In an eighth embodiment, alone or in combination with one or more of the first through eighth embodiments, the cap may be configured to be manually replaced to seal the cavity.

In a ninth embodiment, alone or in combination with one or more of the first through ninth embodiments, the removable portion may be a filter head including the fluid inlet and the fluid outlet, wherein the filter head may be configured to be manually removable from the other portion of the filter housing to provide the access to the removable filtration media.

In a tenth embodiment, alone or in combination with one or more of the first through tenth embodiments, the removable portion may be a filter head including the fluid inlet and the fluid outlet, and the filter head may be fixed to the removable filtration media such that when the filter head may be removed from the other portion of the filter housing the removable filtration media may be removed from the filter housing as a result.

In an eleventh embodiment, alone or in combination with one or more of the first through eleventh embodiments, the filter head may include a key extending radially outward from the filter head and at least one displaceable latch feature extending longitudinally from the filter head.

In a twelfth embodiment, alone or in combination with one or more of the first through twelfth embodiments, after insertion of the water filter cartridge into a manifold including at least one receptacle, a stop element of the at least one receptacle interacts with the at least one displaceable latch feature to prevent rotation of the water filter cartridge in a first direction, and after insertion of the water filter cartridge into the manifold, a curved transition surface of the manifold interacts with the at least one displaceable latch feature to permit rotation of the water filter cartridge in a second direction.

In a thirteenth embodiment, alone or in combination with one or more of the first through thirteenth embodiments, during insertion of the water filter cartridge into a manifold, a latch feature of the at least one displaceable latch feature interacts with a curved interior surface of the manifold, prior to being received by at least one receptacle of the manifold, to force the at least one displaceable latch feature to flex radially inward as a result.

In a fourteenth embodiment, alone or in combination with one or more of the first through fourteenth embodiments, during removal of the water filter cartridge from a manifold, and counterclockwise rotation of the water filter cartridge in the manifold, the at least one displaceable latch feature interacts with a curved transition surface of at least one receptacle of the manifold to force the at least one displaceable latch feature to flex radially inward.

In another aspect, the present invention embraces a filtration media unit. The filtration media unit may include filtration media, and an interface mechanism for providing fluid communication between a fluid inlet of a filter cartridge and the filtration media and the filtration media and a fluid outlet of the filter cartridge. The interface mechanism may be configured to be detachable from the filter cartridge.

The filtration media unit may include additional embodiments, such as any single embodiment or any combination of embodiments described below and/or in connection with one or more other filtration media units described elsewhere herein.

In a first embodiment, the filtration media has a first end, a second end, and a longitudinal axis, and the interface mechanism may be positioned on the first end of the filtration media.

In a second embodiment, alone or in combination with the first embodiment, the interface mechanism may include a cross-over passage to provide the fluid communication between the filtration media and the fluid outlet of the filter cartridge.

In a third embodiment, alone or in combination with one or more of the first and second embodiments, the interface mechanism may include a key extending radially outward from the interface mechanism, and at least one displaceable latch feature extending longitudinally from the interface mechanism.

In a fourth embodiment, alone or in combination with one or more of the first through third embodiments, after insertion of the filtration media unit into a manifold including at least one receptacle, a stop element of the at least one receptacle interacts with the at least one displaceable latch feature to prevent rotation of the filtration media unit in a first direction, and after insertion of the filtration media unit into the manifold, a curved transition surface of the manifold interacts with the at least one displaceable latch feature to permit rotation of the filtration media unit in a second direction.

In a fifth embodiment, alone or in combination with one or more of the first through fourth embodiments, during insertion of the filtration media unit into a manifold, a latch feature of the at least one displaceable latch feature interacts with a curved interior surface of the manifold, prior to being received by the at least one receptacle of the manifold, to force the at least one displaceable latch feature to flex radially inward as a result.

In a sixth embodiment, alone or in combination with one or more of the first through fifth embodiments, during removal of the filtration media unit from the manifold, and counterclockwise rotation of the filtration media unit in the manifold, the at least one displaceable latch feature interacts with a curved transition surface of the at least one receptacle of the manifold to force the at least one displaceable latch feature to flex radially inward.

In yet another aspect, the present invention embraces a method of replacing filtration media within a water filter cartridge. The method may include providing a water filter cartridge. The water filter cartridge may include a filter housing defining a cavity, a fluid inlet and a fluid outlet positioned on the filter housing and in fluid communication with the cavity, and a first removable filtration media positioned within the cavity. The filter housing may be configured to provide access to the first removable filtration media. The method may further include manipulating the filter housing to obtain the access to the first removable filtration media, removing the first removable filtration media from the cavity, inserting a second removable filtration media into the cavity, and manipulating the filter housing to seal the cavity.

The method of replacing filtration media within a water filter cartridge may include additional embodiments, such as any single embodiment or any combination of embodiments described below and/or in connection with one or more other methods described elsewhere herein.

In a first embodiment, the water filter cartridge may be the water filter cartridge of any one of the previous embodiments.

In yet another aspect, the present invention embraces a water filter cartridge. The water filter cartridge may include a filter housing a having a first end, a second end, and a longitudinal axis, wherein the filter housing defines a cavity. The first end may include connecting means for operably coupling with a manifold of an appliance, a fluid inlet and a fluid outlet at the first end of the filter housing, and a removable filtration media positioned within the cavity. The filter housing may be configured to provide access to the removable filtration media.

The water filter cartridge may include additional embodiments, such as any single embodiment or any combination of embodiments described below and/or in connection with one or more other water filter cartridges described elsewhere herein.

In a first embodiment, the removable filtration media may be configured to be manually removed from the cavity.

In a second embodiment, alone or in combination with the first embodiment, the filter housing may include a cross-over passage in fluid communication with the fluid outlet and the removable filtration media.

In a third embodiment, alone or in combination with one or more of the first and second embodiments, the removable filtration media may include a cross-over passage in fluid communication with the fluid outlet.

In a fourth embodiment, alone or in combination with one or more of the first through third embodiments, the water filter cartridge may include a filtration media unit including the removable filtration media.

In a fifth embodiment, alone or in combination with one or more of the first through fourth embodiments, the fluid inlet and the fluid outlet are configured to engage a manifold of an appliance, and the water filter cartridge may be configured to be removable from the appliance.

In a sixth embodiment, alone or in combination with one or more of the first through fifth embodiments, the filter housing may include a removable portion configured to be removed from another portion of the filter housing to provide the access to the removable filtration media.

In a seventh embodiment, alone or in combination with one or more of the first through sixth embodiments, the removable portion may be a cap configured to engage the filter housing and seal the cavity, wherein the cap may be configured to be manually removable from the other portion of the filter housing to provide the access to the removable filtration media.

In an eight embodiment, alone or in combination with one or more of the first through seventh embodiments, the cap may be configured to be manually replaced to seal the cavity.

In a ninth embodiment, alone or in combination with one or more of the first through eighth embodiments, the removable portion may be a filter head including the fluid inlet and the fluid outlet, wherein the filter head may be configured to be manually removable from the other portion of the filter housing to provide the access to the removable filtration media.

In a tenth embodiment, alone or in combination with one or more of the first through ninth embodiments, the removable portion may be a filter head including the fluid inlet and the fluid outlet, and the filter head may be fixed to the removable filtration media such that when the filter head may be removed from the other portion of the filter housing the removable filtration media may be removed from the filter housing as a result.

In an eleventh embodiment, alone or in combination with one or more of the first through tenth embodiments, the filter head may include a key extending radially outward from the filter head and at least one displaceable latch feature extending longitudinally from the filter head.

In a twelfth embodiment, alone or in combination with one or more of the first through eleventh embodiments, after insertion of the water filter cartridge into a manifold including at least one receptacle, a stop element of the at least one receptacle interacts with the at least one displaceable latch feature to prevent rotation of the water filter cartridge in a first direction. After insertion of the water filter cartridge into the manifold, a curved transition surface of the manifold interacts with the at least one displaceable latch feature to permit rotation of the water filter cartridge in a second direction.

In a thirteenth embodiment, alone or in combination with one or more of the first through twelfth embodiments, during insertion of the water filter cartridge into the manifold, a latch feature of the at least one displaceable latch feature interacts with a curved interior surface of the manifold, prior to being received by the at least one receptacle of the manifold, to force the at least one displaceable latch feature to flex radially inward as a result.

In a fourteenth embodiment, alone or in combination with one or more of the first through thirteenth embodiments, during removal of the water filter cartridge from the manifold, and counterclockwise rotation of the water filter cartridge in the manifold, the at least one displaceable latch feature interacts with the curved transition surface of the at least one receptacle of the manifold to force the at least one displaceable latch feature to flex radially inward.

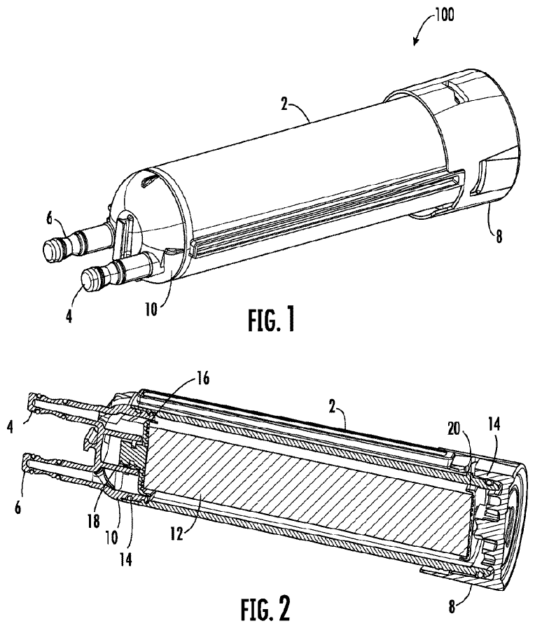

FIGS. 1 and 2 illustrate a perspective view and a cross-sectional perspective view, respectively, of a water filter cartridge 100, in accordance with an embodiment of the invention. As shown in FIG. 1, the water filter cartridge 100 includes a filter housing 2 defining a cavity. Filter housing 2 is substantially hollow and cylindrical in shape, with a substantially tubular void therein. Additionally, or alternatively, the filter housing 2 may be slightly conical such that the first end is has a smaller radius than the radius of the second end. The filter housing 2 defines a first end and a second end, and a longitudinal axis therebetween.

In some embodiments, positioned on the first end may be a fluid inlet 4 and a fluid outlet 6. The fluid inlet 4 and fluid outlet 6 may be configured to be in fluid communication with the cavity of the filter housing 2, in order to transport a fluid such as water. The fluid inlet 4 and the fluid outlet 6 may be coupled to a head 10, which may, in some embodiments, be separable from the filter housing 2. Head 10 may also comprise one or more snap features structured to matingly engage with one or more snap receptacles on the inner or outer surfaces of the filter housing 2. Various embodiments of head 10 are contemplated herein, in order to interface with a manifold of a range of appliances, and such embodiments will be described with greater detail herein in FIGS. 6-36.

In some embodiments, positioned on the second end of the filter housing 2 may be a removable portion such as a cap 8, the cap 8 structured to be removably coupled to the filter housing 2 to provide access to the cavity of the filter housing 2. The cap 8 may be comprised of one or more apertures, the apertures structured to receive one or more corresponding protuberances on the outer surface of the filter housing 2, such that the cap 8 is held in place securely. Likewise, in some embodiments, cap 8 may comprise one or more snap features structured to matingly engage with one or more snap receptacles on the inner or outer surfaces of the filter housing 2.

Water filter cartridge 100 may also comprise one or more seals 14, at least one of the seals 14 positioned between cap 8 and the outer surface of the filter housing 2, and at least one of the seals 14 positioned between head 10 and the filter housing 2. The seals 14 are compressed by material interference between the filter housing 2, the seals 14, and either the head 10 or cap 8, such that fluid is prevented from leaking between any gaps between adjacent surfaces of the cap 8 or the head 10 and the filter housing 2. In the embodiment depicted in FIG. 2, the seal 14 between the head 10 and the filter housing 2 is shown as being substantially similar in size to the seal 14 between the cap 8 and the filter housing 2. It shall be understood that in some embodiments, seals 14 may be sized differently from one another, such as to accommodate various sizes of cap 8, head 10, and filter housing 2.

By removing the cap 8, a user may have access to the removable filtration media 12. Filtration media 12 may be comprised of any number of compounds, elements, or chemicals structured to remove, filter, or otherwise neutralize contaminants or objects from the fluid once the fluid enters the fluid inlet 6 and passes through the filtration media 12. Examples include, but are not limited to: carbon, sediment, reverse osmosis filter, deionizing filters, or the like. The filtration media 12 may be defined by a first end and a second end, and may be substantially cylindrical in shape. In some embodiments, the filtration media 12 may also comprise an aperture extending from the first end towards the second end, such as to form a cavity within the filtration media 12.

In some embodiments not depicted, the removable portion of the reusable water filter cartridge 100 may be the head 10, while the cap 8 may be structured with snap features or otherwise sealingly engaged with the filter housing 2. As previously described, the head 10 may include a fluid inlet 4 and a fluid outlet 6 structured to be in fluid communication with at least a portion of the cavity within the filter housing 2. In such an embodiment, the head 10 may be structured to be removably coupled to the filter housing 2 to provide access to the cavity of the filter housing 2. The head 10 may be comprised of one or more apertures, the apertures structured to receive one or more corresponding protuberances on the outer surface of the filter housing 2, such that the head 10 is held in place securely. In this way, a user may remove the head 10 to access and remove the filtration media 12, or in some embodiments the filtration cartridge.

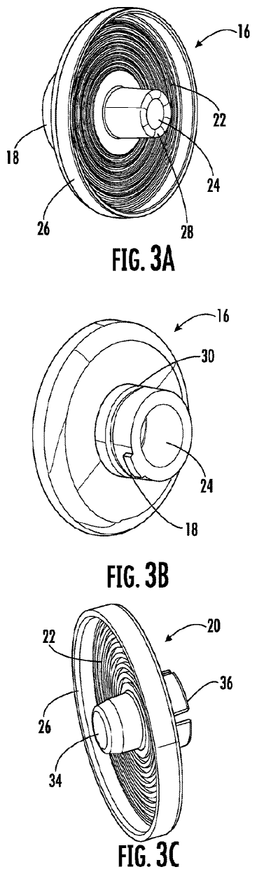

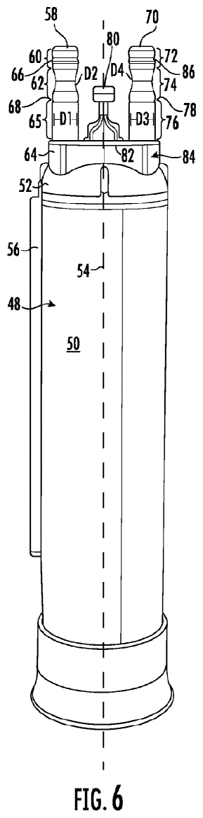

Still referring to FIG. 2, adjacent the first end of the filtration media 12 is the interface mechanism 16, structured to receive fluid after the fluid has interacted with the filtration media 12, and thereafter direct the fluid through a first protuberance 18 and to the fluid outlet 4. Various embodiments of interface mechanisms 16 and 38 will be described in greater detail hereinafter with reference to FIGS. 3A-3B and 5A-5B. Adjacent the second end of the filtration media 12 is the endcap 20.

After the water filter cartridge 100 has been positioned within a manifold of an appliance, the fluid inlet 4 and the fluid outlet 6 of the head 10 may be in fluid communication with the manifold. Accordingly, the water filter cartridge 100 may receive unfiltered water through a fluid passageway of the manifold, which is in fluid communication with the fluid inlet 4. After passing through the filtration media 12, the filtered water exits the water filter cartridge 100 through the fluid outlet 6 and enters a corresponding fluid passageway of the manifold.

FIGS. 3A-3B illustrate perspective views of an interface mechanism 16, in accordance with an embodiment of the invention. Interface mechanism 16 is primarily disk-shaped, defining a first face and a second face. The second face of the interface mechanism 16 is structured with a plurality of grooves 22, the grooves 22 configured to be positioned adjacent the first end of the filtration media 12. Along the perimeter of interface mechanism 16 is a wall 26 extending from the first face, past the second face, the interior of which defines a cylindrical face structured to be adjacent the outer surface of the filtration media 12. The interface mechanism 16 also includes a first protuberance 18 extending from the first face of the interface mechanism 16 towards the head 10, the outer surface of the first protuberance 18 structured to matingly engage with a corresponding aperture of the head 10. Moreover, one or more seals 30 may be positioned adjacent the outer surface of the first protuberance 18 in order to sealingly engage the interface mechanism 16.

In an embodiment including the interface mechanism 16, the head 10 may be structured such that the corresponding aperture of head 10 is in fluid communication with the fluid outlet 4. The interface mechanism 16 also includes a second protuberance 28 extending from the second face of the interface mechanism 16 towards the filtration media 12, the outer surface of the second protuberance 28 structured to matingly engage with a corresponding aperture of the filtration media 12.

The first and second protuberances 18, 28, as shown in FIGS. 3A-3B, are positioned along the axis defining the filtration cartridge 2. The first and second protuberance 18,28 may be sized similarly or dissimilarly relative one another, depending on the structures of the corresponding head 10 and filtration media 12. An aperture 24 extends between the first and second protuberances 18, 28 such that fluid, having already contacted the filtration media 12, may move from the filtration media 12, through the interface mechanism 16, and finally to the head 10 including the fluid outlet 4.

FIG. 3C illustrates a perspective view of an endcap 20, in accordance with an embodiment of the invention. Endcap 20 is primarily disk-shaped, defining a first face and a second face. The first face of the endcap 20 is structured with a plurality of grooves 22, the grooves 22 configured to be positioned adjacent the second end of the filtration media 12. Along the perimeter of endcap 20 is a wall 26 extending from the second face, past the first face, the interior of which defines a cylindrical face structured to be adjacent the outer surface of the filtration media 12. The endcap 20 also includes a protuberance 36 extending from the second face of the endcap 20 towards the cap 8, the outer surface of the protuberance 36 structured to matingly engage with a corresponding aperture of the cap 8.

The endcap 20 also includes a plug 34 extending from the first face of the endcap 20 towards the filtration media 12, the outer surface of the plug 34 structured to matingly engage with a corresponding aperture of the filtration media 12. Unlike the aperture 24 of the interface mechanism 38 in FIGS. 3A-3B, the outer surface of the plug 34 is continuous and no such aperture is present in the plug 34.

In some embodiments, a filtration cartridge may be provided, the filtration cartridge having a filtration media 12, the interface mechanism 16 adjacent the first end of the filtration media 12, and an endcap 20. In this way, a user may remove the existing filtration cartridge from the water filter cartridge 100 and replace it with another filtration cartridge.

FIGS. 5A-5B illustrate perspective views of an interface mechanism 38, in accordance with an embodiment of the invention. Similar to the interface mechanism 16, the interface mechanism 38 of the present embodiment is primarily disk-shaped, defining a first face and a second face. The second face of the interface mechanism 38 is structured with a plurality of grooves 22, the grooves 22 configured to be positioned adjacent the first end of the filtration media 12. Along the perimeter of interface mechanism 38 is a wall 26 extending from the first face, past the second face, the interior of which defines a cylindrical face structured to be adjacent the outer surface of the filtration media 12. The interface mechanism 38 also includes a first protuberance 18 extending from the first face of the interface mechanism 38 towards the head 10.

Unlike the interface mechanism 16 described with respect to FIGS. 3A-3B, here the outer surface of the first protuberance 18 of the interface mechanism 38 is structured to matingly engage and be in fluid communication with a corresponding aperture of the fluid outlet 4. As such, the first protuberance 18 may be positioned off-center from the axis defining filter housing 2 in the event that the fluid outlet 4 is positioned off-center from the axis relative the filtration cartridge 2. The first protuberance 18 defines a first aperture 46. Moreover, one or more seals 42 may be positioned adjacent the outer surface of the first protuberance 18 in order to sealingly engage the fluid outlet 4.

The interface mechanism 38 also includes a second protuberance 28 extending from the second face of the interface mechanism 38 towards the filtration media 12, the outer surface of the second protuberance 28 structured to matingly engage with a corresponding aperture of the filtration media 12. The second protuberance 28 defines a second aperture 24. The first and second protuberances 18, 28 may be sized similarly or dissimilarly relative one another, depending on the structures of the corresponding fluid outlet 4 and filtration media 12. The first and second apertures 24, 46 are in fluid communication with each other, defining a cross-over passage 44 therebetween. In this way, fluid having already contacted the filtration media 12 may move from the filtration media 12, through the cross-over passage 44 of the interface mechanism 38, and finally to the fluid outlet 4.

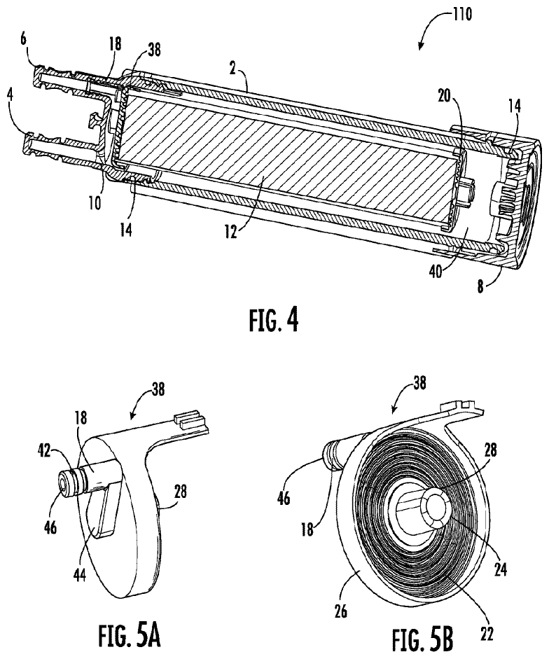

Referring now to FIG. 4, wherein another embodiment of a water filter cartridge 110 having interface mechanism 38 is exemplified in a cross-section view, it shall be appreciated that when interface mechanism 38 is configured as shown, the position of the filtration media 12 is in closer in proximity to head 10, thereby introducing a void 40 between the endcap 20 and the cap 8. As such, the length of filtration media 12 may be lengthened between the first end and the second end (not shown in FIG. 4), such as to fill the void 40. By increasing the distance between the first end and the second end of the filtration media 12, the filtration media 12 may be lengthened, thus increasing the surface area of the filtration media 12 in contact with the fluid. As such, the lifespan of the filtration media 12 may be increased, or in some embodiments such a lengthening of the filtration media 12 may results in the improvement of removal of contaminants or suspended articles in the fluid.

The foregoing embodiments and elements of the foregoing embodiments may be combined with one or more features, embodiments, examples, elements, and/or the like described hereinafter. For example, the foregoing embodiments of a water filter cartridge may include features and/or elements of the heads set forth in the following description.

FIG. 6 illustrates a side view of a water filter cartridge including a head, in accordance with an embodiment of the invention. As shown in FIG. 6, filter housing assembly, comprising a housing 48 with a substantially cylindrical body 50 and a top portion 52 for forming a fluid-tight seal with the body. A strengthening rib 56 runs along the length of the cylindrical body 50, parallel to a longitudinal axial center line 54. The top portion 52 is depicted as substantially dome-shaped to facilitate the filter housing assembly as a pressurized vessel; however, it may be a flat surface if design constraints require. The cylindrical body 50 and housing top portion 52 share the longitudinal axial center line 54. A protrusion extends in the axial direction upwards from top portion 52, and outwards in a radial direction about the axial center 54. Dimensionally, the protrusion extends upwards approximately 0.15-0.35 inches- and preferably 0.24 inches—from the top surface of the housing top portion 52. Housing 48 may hold a filtration media therein for the filtration of fluids, may act as a sump, or may act as a bypass filter cartridge having no filtration media. Housing 48 is further adapted to receive a connection assembly 84 which consists of an electronic circuit component and a housing 64 for receiving said electronic circuit component therein.

As shown in FIG. 6, an ingress port 58 is demarcated into three distinct segments: a first or top segment 60, a second or middle segment 62, and a third or bottom segment 65. The third or bottom segment 65 extends vertically upwards in a longitudinally axial direction from the surface of housing top portion 52 substantially parallel to the axial center line 54. The ingress port bottom segment 65 is separated from middle segment 62 by seal 68. The ingress port top segment 60 extends from the ingress port middle segment 62 upwards to the topmost surface of the port, and is separated from middle segment 62 by seal 66. Seals 66 and 68 prohibit fluid exiting ingress port middle segment's aperture or cavity a from contacting the outer surface of the ingress port top and bottom segments 60, 65, respectively, once the ingress port is inserted within a receiving filter base stanchion. Seals 66 and 68 provide a circumferential press-fit or sealing force against the inner cylindrical wall of the stanchions of the filter base (not shown). Seals 66, 68 are held in place on the ingress port typically by insertion into a groove within the ingress port cylindrical outer surface, such that a diameter D1 of the outermost seal radial extension is slightly greater than the inner wall diameter of the receiving stanchion, allowing the resilient, compressible seals to be compressed by the inner wall of the receiving stanchion upon insertion.

In at least one embodiment, ingress port middle segment 62 has a varying diameter D2 unequal to, and less than D1, such that the ingress port middle segment 62 is formed having an outer surface contour to allow for fluid to flow around the middle segment 62 after the ingress port 58 is inserted into its respective stanchion. Fluid exiting the filter base stanchion is contained by and between seals 66, 68 and the circumferential stanchion inner wall. The fluid traverses around the ingress port middle segment and enters the ingress port middle segment aperture or cavity.

In the embodiment depicted in FIG. 6, the outer surface contour of ingress middle segment 62 is depicted in the form of an hourglass shape having a smaller diameter at its center than at either the topmost or bottommost points of the middle segment closest to the seals 66, 68. The ingress port middle segment's body may be formed of other shapes as well, such as a smaller cylindrical shape having a diameter less than D1, a rectangular or triangular segment, or cone-shaped architecture, wherein the middle segment 62 has at least one area where its measured diameter is less than diameter D1, providing an annular space for fluid to flow around the middle segment structure to allow fluid, exiting the filter base input port into the stanchion to enter the ingress port middle segment's aperture or cavity.

Preferably, ingress port 58 is substantially cylindrical at its top and bottom segments to correspond to the cylindrical cavity of its respective receiving stanchion. The measurements of the outermost surface contour of ingress port 58 at the seals 66, 68/stanchion inner wall interface, which is identified by diameter D1, may be between 0.25-0.45 inches- and optionally 0.36 inches—while the ingress middle segment diameter D2 of ingress port 58 may be between 0.2-0.4 inches, and optionally 0.28 inches. The middle segment diameter D2 is less than diameter D1 and the diameter of the receiving stanchion to achieve fluid flow about and around the ingress port middle segment from the exit port of the stanchion on one side to the input aperture a of the middle segment to the other side. A fluid seal is still maintained during such instances of fluid flow, such that fluid is prohibited from contacting the outer surface of the ingress port top or bottom segments. This allows for the outer surface contour of ingress middle segment 62 to be less than, and within, the compressed sealing diameter D1 at the filter base's stanchion inner wall.

An egress port 70 similarly having a substantially cylindrical body with a first or top segment 72, a second or middle segment 74, and a third or bottom segment 76, extends vertically upwards in a longitudinally axial direction from the top surface of housing top portion 52 substantially parallel to top portion axial center 54. The egress port top segment 72 extends from its topmost point downwards to the egress port middle segment 74, and is separated from middle segment 74 by a seal 78. The egress port bottom segment 76 extends from housing top portion 52 upwards to the egress port middle segment 74, and is separated from middle segment 74 by seal 86. Seals 86, 78 prohibit fluid exiting the egress port middle segment 74 aperture or cavity 640b from contacting the outside surface of egress port top and bottom segments 72, 76, respectively. Seals 86, 78 provide a circumferential press-fit or sealing force against the inner cylindrical wall of the receiving stanchion of the filter base (not shown). Seals 86, 78 are held in place on the egress port typically by insertion within a groove on the egress port outer wall surface, such that a diameter D3 of the outermost seal radial extension is slightly greater than the inner wall diameter of the receiving stanchion allowing the resilient, compressible seals to be compressed by the inner wall of the receiving stanchion upon insertion. In a similar fashion as the ingress port, the egress port middle segment 74 may be formed in other shapes that allow fluid to flow around the middle segment when the middle segment is placed within the receiving filter base stanchion. In the embodiment depicted in FIG. 6, the outer surface contour of egress middle segment 74 is depicted in the form of an hourglass shape having a smaller diameter D4 at its center than at either the topmost or bottommost points of the middle segment closest the seals 86, 78. The egress port middle segment's body may be formed of other shapes as well, such as a smaller cylindrical shape having a diameter less than D3, a rectangular or triangular segment, or cone-shaped architecture, wherein the middle segment 74 has at least one area where the surface contour radial extension remains within the constraints of diameter D3 to allow fluid, exiting egress port middle segment's aperture or cavity and contained by seals 86, 78 and the circumferential stanchion inner wall, to flow around the egress port middle segment to the opposite side for input into the filter base from an aperture in the receiving stanchion.

The ingress port segments 60-65 and egress port segments 72-76 may each have outer surface contours separate and distinct from one other. In the alternative, ingress port segments 60-65 and egress port segments 72-76 may have substantially similar outer surface topologies. In any case, the respective middle segments will have an outer surface topology (e.g., the outer diameter in a substantially cylindrically shaped embodiment) that has an outer surface contour with a diameter or width that is less than the inner wall of the receiving filter base stanchion by an amount sufficient to create an annular gap that allows fluid to flow around and about the middle segments between their respective upper and lower seals.

The measurements of outermost diameter D3 of egress port 70 at the seal/stanchion inner wall interface may be between 0.25-0.45 inches- and optionally 0.36 inches—while the egress middle segment 74 diameter D4 of egress port 70 may be between 0.2-0.4 inches, and optionally 0.28 inches. The middle segment smaller radial extension D4 is less than diameter D3 to achieve fluid flow about and around the egress port middle segment. This allows for the outer surface contour radial extension of ingress middle segment 62 to be less than the compressed sealing diameter at the manifold's stanchion inner wall.

Ingress port 58 and egress port 70 both include aperture or cavity located on their respective middle segments 62, 74 for the passage of fluid. The ingress port and egress port apertures or cavities are exposed in a direction facing away from the filter base stanchion apertures that are in fluid communication with apertures. The opposing placement of the apertures is helpful because upon extraction of the filter cartridge, if ingress and egress apertures are in a direction facing the filter base stanchion apertures (defined simply as a means of convention as a forward direction), any fluid that drains from apertures may drip upon the electronics and electronic surfaces populated on the electronic circuit component or printed circuit board located forward of the filter key in a PCB housing 64. Once the filter housing 48 is installed in the filter base or manifold, the cavities of the ingress and egress ports are designed to be facing away from the filter base ports (not shown). Water flowing through housing assembly thus enters and exits the cavities, flows around the middle segments 62, 74 of the ingress and egress ports within the manifold stanchions, and continues into the ports. The variable radial extensions or diameters D2, D4 of the middle segments 62, 74, respectively, allows for the water to flow around the ingress and egress port middle segments within the stanchion's cylindrical cavity without building undue pressure that could otherwise force a leak through the seals 66, 68, 86, 78 and onto the filter housing assembly, which would otherwise cause damage to the electronics disposed on the printed circuit board as further described below.

Ingress port and egress port 58, 70 extend from, and are substantially perpendicular to, a non-diameter chord line C1 of the housing top portion 52. Moving the ingress and egress ports off a corresponding parallel diameter of the housing top portion is helpful to allow for sufficient space on the housing top portion 52 for placement of the PC board housing 64 and PC board. Dimensionally, the distance between chord line C1 and a parallel diameter of housing top portion 52 may be between 0.1-0.5 inches, and optionally 0.3 inches. The ingress and egress ports are off-diagonal center in order to accommodate the remaining particular features of the housing assembly. Ingress port 58 and egress port 70 are spaced apart from each other on chord line C1 by approximately 0.65-0.85 inches, and optionally 0.74 inches. The filter key 80 is centered on, and perpendicularly intersects with, chord line C1.

A “diameter” as used herein, may refer to a straight line passing through corresponding sides of the component/portion/segment, such as that of the port (ingress port 58 and/or egress port 70). Typically, the diameter is a straight line passing through opposite sides of the component/portion/segment, such as that of the port (ingress port 58 and/or egress port 70), e.g., in a plane perpendicular to the central axis of the water filter cartridge. Here, the length of the diameter is the perpendicular distance between the opposite sides of the component/portion/segment, e.g., in a plane perpendicular to the central axis. In some instances, the diameter line passes through a center, a centroid, a focus, a center of curvature, a circumcenter, and/or another center of a circular or non-circular cross-section of the component/portion/segment, such as that of the port (ingress port 58 and/or egress port 70) along the plane perpendicular to the central axis. In some instances, e.g., where the portion/segment of the port (ingress port 58 and/or egress port 70) comprises a circular or oval cross section, the diameter line may pass through a center and/or a focus of the cross section.

The filter key 80 structured for mating attachment to a filter base or manifold is located on or connected to the housing 48, and extends upwards in a direction parallel to the axial center 54 of the housing top portion 52. Filter key 80 comprises a base having a front lateral side 82a, and a rear or back lateral side 82b, with a groove running therethrough for receiving protrusion on housing top portion 52, and lengthwise or longitudinal sides running substantially parallel to protrusion. Filter key 80 is secured to the housing top portion 52 via the connection between groove and protrusion.

Base extends upward along the housing top portion axial center 54, having the exposed front face and back face 82a, 82b, respectively, and two exposed longitudinal side faces. A cross-section of the base in a plane parallel to the front and back lateral faces 82a,b depicts longitudinal sides gradually tapering inward through the upward extension, and then projecting upwards parallel to the central axis to a top surface that supports a finger or a plurality of fingers as discussed further below.

From the top of base extends finger (and in at least one other embodiment, a plurality of extending fingers), the finger extending substantially parallel to the exposed front and back lateral faces or sides 82a,b, and substantially perpendicular to the housing top portion axial center line 54. Finger(s) further includes on one side a contacting portion forming substantially a first angle and exposed in a first direction with respect to the housing top portion, which presents a camming surface for slidably mating with a filter base drive key.

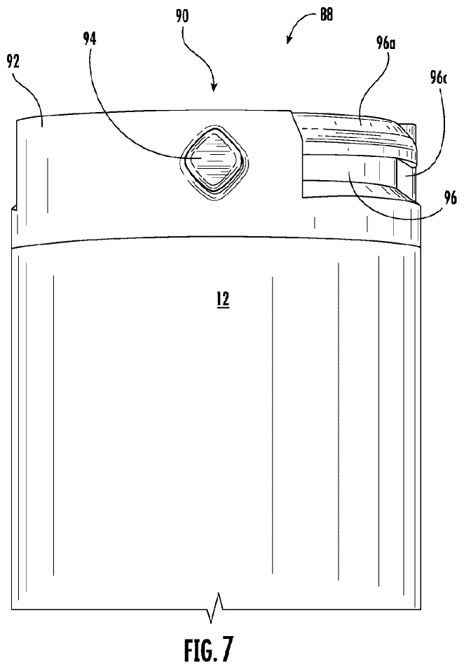

FIG. 7 illustrates a side view of a water filter cartridge including a head, in accordance with an embodiment of the invention. As shown in FIG. 7, the head 92 may include a key 94 and a channel 96. In some embodiments, the key 94 may extend radially outward from the head 92 (e.g., from an outer surface of the head 92 and/or the like). Although not shown in FIG. 7, the head 92 may include another channel positioned on the opposite side of the head 92 from the channel 96. In some embodiments, the channels 96 may be positioned and/or formed on an outer surface of the head 92. Additionally, or alternatively, the channels 96 may be diametrically opposed on the outer surface of the head. In some embodiments, and as described herein, the channels 96 may be structured and/or configured for receiving latching mechanisms, preventing rotation of the filter cartridge in a first direction, and permitting rotation of the filter cartridge in a second direction.

The channel 96 may include a chamfered edge 96a oriented towards the fluid inlet and outlet 90, a vertical sidewall 24b on a first end of the channel 96, and a filleted or curved sidewall 96c on a second end of the channel 96. As described further herein, the chamfered edge 96a, the vertical sidewall 96b, and the filleted sidewall 96c may interact with corresponding features on a lock mechanism on a filter cartridge manifold. As shown in FIG. 7, the key 94 may be shaped as an extruded rhombus with a tip that is sloped from its center, and, as described further herein, the key 94 may interact with keyways in a tube of the filter cartridge manifold. In some embodiments, the key 94 may have a rhomboid-shape and a radially-outward-facing surface that is sloped radially inward from a center of the radially-outward-facing surface.

FIG. 8 illustrates a partial cross-sectional view of a water filter cartridge including a head, in accordance with an embodiment of the invention. As shown in FIG. 8, a close-up, cross-section schematic view of a media cartridge 100, where the inlet 102 receives fluid, for example water, to be processed and the outlet 104 receives processed fluid. Fluid entering the media cartridge 100 passes through the inlet 102 and hits valve 130, which is an exemplary bypass regulator, entering the feed chamber 106. The feed then either passes through the feed separator 108 (optional), which aids in keeping the media from escaping the media compartment 114 or through the bypass port 118 into the mixing compartment 116. The amount of fluid going into the mixing compartment 116 is related to the flow through bypass port 118, which is regulated by the valve 130 in conjunction with the elastic device 119 and with a portion of the first/upper end cap 120, which in this embodiment has an extension with one section having a first, enlarged diameter to block the bypass port 118 when the valve is in one position and a second section have a second, narrower diameter to permit flow through the bypass port 118. End cap sleeve 126 in combination with filter element cover 128 contains the filter element 122. Flow of fluid from the bypass port goes through the outer diameter of the filter element 122 and into filter core 124, out the passage of the end cap 120 to outlet 104. Drive 159 imparts linear force on valve 130 in order to adjust the amount of bypass fluid flow.

The body or housing of the cartridge typically comprises a top or sump cover 109 and a sump 113.

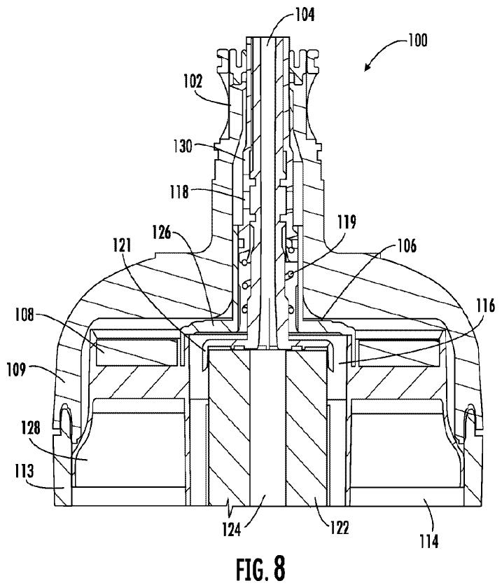

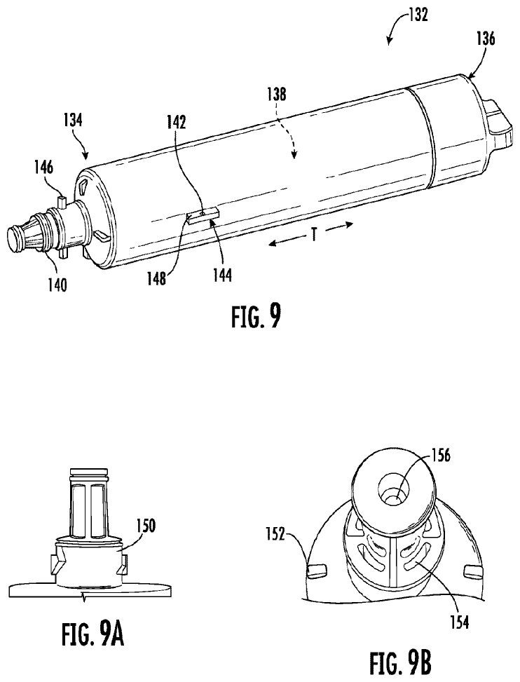

FIG. 9 illustrates a perspective view of a water filter cartridge including a head 134, in accordance with an embodiment of the invention. As shown in FIG. 9, filter cartridge 132 may define an alignment feature 144 and the filter housing may define a complementary feature. In general, filter cartridge 132 is properly installed when the alignment feature 144 engages complementary feature. It should be appreciated that alignment feature 144 and a complementary feature may be any suitable features. For example, according to an exemplary embodiment, alignment feature 144 is one or more radial lugs 146 that extend radially outward from connection 140. Radial lugs 146 may be configured for engaging a complementary keyed slot defined in filter manifold.

Referring still to FIG. 9, alignment feature 144 may include a radially extending member or tag 148 which extends from sidewall of filter cartridge 132. The complementary feature may include a wall or stopping member. In this regard, the stopping member may be defined in a drain trough defined by the filter housing. In this manner, the filter cartridge 132 may be rotated until radially extending tag 148 engages the stopping member to properly position filter cartridge 132 within the filter housing. In this regard, filter cartridge 132 is in the proper position only when radially extending tag 148 extends downward along the vertical direction V. According to an exemplary embodiment, a first contact may be positioned on a stopping member and second contact 142 may be positioned on radially extending tag 148 to form an electrical connection.

FIG. 9A illustrates a perspective view of a head, in accordance with another embodiment of the invention. As shown in FIG. 9A the head may include one or more flanges 150 surrounding the perimeter of at least of portion of the head. The flanges 150 extend radially and are configured to matingly engage with at least a portion of the manifold such as to guide and lock the head in place within the manifold.

FIG. 9B illustrates a perspective view of a head, in accordance with another embodiment of the invention. As shown in FIG. 9B, the head may include at least one tab 152 positioned radially adjacent the perimeter of the outermost portion of the head. The tabs may provide structural rigidity to the head, or function to offset the placement of the head relative the manifold. The head may also include at least one radial slot aperture 154, and aperture 156. Radial slot apertures 154 and aperture 156 may be structures to provide fluid inflow or outflow to the head.

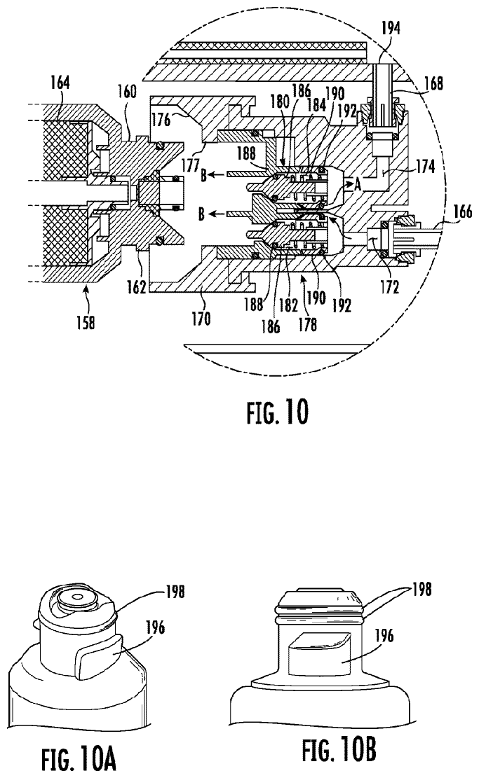

FIG. 10 illustrates a partial cross-sectional view of a water filter cartridge including a head, in accordance with an embodiment of the invention. As shown in FIG. 10, the head is provided with a plug 160 and in turn, the plug 160 is inserted into the valve assembly 178. The plug 160 is formed at an outer peripheral surface thereof with coupling protrusions 162 coupling the valve assembly 178.

Although the present embodiment illustrates the coupling protrusions 162 and holding protrusions 177 as elements to couple or separate the filter assembly 158 to or from the valve assembly 178, this is given only by way of example, and other known elements, such as, e.g., latches or hooks, may be provided. The other end of the filter housing is provided with a plug 160 and in turn, the plug 160 is inserted into the valve assembly 178. The plug 160 is formed at an outer peripheral surface thereof with coupling protrusions 162 coupling the valve assembly 178.

The valve assembly 178 includes a valve housing 170 and a valve unit 180 reciprocally movably provided in the valve housing 170, the valve unit 180 to control the supply of water to the filter assembly 158 and/or the water tank unit. The valve housing 170 is formed in one side thereof with an inlet path 166 for introduction of the water supplied from the water supply source and an outlet path 174 for discharge of the water purified by the filter unit 158. In addition, the other side of the valve housing 170 is provided with a socket 176, into which the plug 160 of the filter assembly 158 is inserted. The inlet path 172 is connected to the first water supply pipe through an inlet pipe 166 and thus, the water supplied from the water supply source is introduced into the inlet path 166 through the first water supply pipe. The socket 176 is formed at an inner peripheral surface thereof with holding protrusions 177 to be caught and supported by the coupling protrusions 162 of the plug 160 when the plug 160 is inserted into the socket 176 and is rotated by 90 degrees.

With the above-described configuration, if the handle is rotated in a given direction by 90 degrees after the filter assembly 158 is inserted into a filter receiving region of the case, the coupling protrusions 162 of the filter assembly 158 are caught and supported by the holding protrusions 177 of the valve assembly 178, completing the installation of the filter assembly 158. Upon replacement of the filter assembly 158, the filter assembly 158 is separable from the case as the handle is pulled out after being rotated in an opposite direction. Although the present embodiment illustrates the coupling protrusions 162 and holding protrusions 177 as elements to couple or separate the filter assembly 158 to or from the valve assembly 178, this is given only by way of example, and other known elements, such as, e.g., latches or hooks, may be provided.

The valve assembly 178, as shown in FIG. 10, has a bypass path A to prevent leakage of water from the valve housing 170 upon separation of the filter assembly 158. The bypass path A is created by the valve unit 180 reciprocally movably provided in the valve housing 170.

Specifically, when the filter assembly 158 is separated from the valve assembly 178, a first communicating path 182 and a second communicating path 184 are closed respectively by shutter members 186. Here, the first communicating path 182 communicates the inlet path 172 and the filter assembly 158 with each other, and the second communicating path 184 communicates the outlet path 174 and the filter assembly 158 with each other.

More specifically, as the shutter members 186 are pressed toward the filter assembly 158 by elastic members 190, the first and second communicating paths 182 and 184 are closed respectively by first sealing members 188 provided at outer peripheral surfaces of the shutter members 186. Also, as the valve unit 180 is moved leftward in a direction represented by the arrows B under the influence of a pressure of the water introduced through the inlet path 172, the bypass path A for communication between the inlet path 172 and the outlet path 174 is created.

On the other hand, when the filter assembly 158 is coupled to the valve assembly 178, the filter assembly 158 presses the valve unit 180 and the shutter members 186, thus causing the bypass path A to be closed by second sealing members 192 while opening the first and second communicating paths 182 and 184.

With the above-described configuration, even if the water supply system is operated during replacement of the filter assembly 158, it may effectively prevent water from being supplied to the filter assembly 158 and consequently, prevent deterioration in the operational reliability of the water supply system due to water leakage.

FIG. 10A illustrates a perspective view of a head, in accordance with the embodiment of FIG. 10. As shown in FIG. 10A, the head may include one or more flanges 196 surrounding the perimeter of at least of portion of the head. The flanges 196 extend radially and are configured to matingly engage with at least a portion of the manifold such as to guide and lock the head in place within the manifold. The head may also include one seal 198 such as an o-ring, gasket, or the like.

FIG. 10B illustrates a perspective view of a head, in accordance with the embodiment of FIG. 10. Similar to the embodiment illustrated in FIG. 10A, the head may include one or more flanges 196 surrounding the perimeter of at least of portion of the head. Unlike the embodiment illustrated in FIG. 10A, the embodiment illustrated in FIG. 10B may include a plurality of seals 198, such as to more effectively sealingly engage with the manifold and create prevent fluid from the inlet of the head from contaminating the fluid from the outlet, and vice versa. Moreover, such seals 198 may also prevent the spillage of fluid into the appliance or outside the manifold.

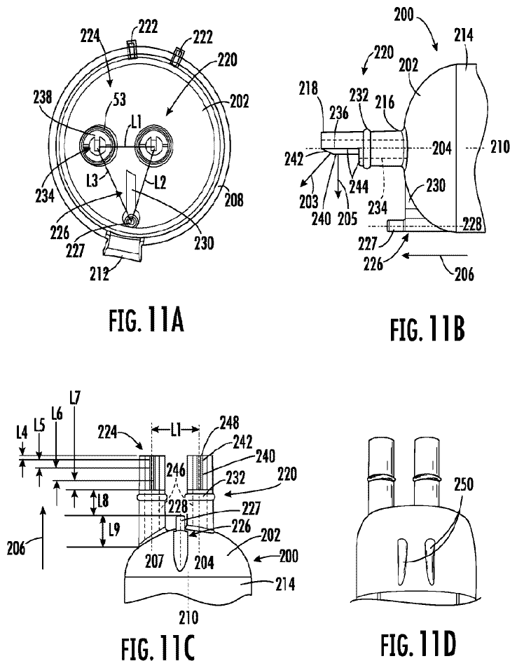

FIGS. 11A-11D illustrate a rear, side, and top plan views of a head, in accordance with an embodiment of the invention. As shown in FIGS. 11A-11C, the head 200 includes an end piece wall 202, an inlet fitting 220, an outlet fitting 224, and a protrusion 226. The cartridge housing 208 may be cylindrical and hollow, having a first end 214 and a closed end opposite the first end 214. The housing 208 may optionally be structurally reinforced by ribs or the like.

The inlet fitting 220 and the outlet fitting 224 extend from the end piece wall 202 such that the inlet fitting 220 is more in-line with the center axis of the cartridge, closer to the center of the end piece wall 202 while the outlet fitting 224 is further from the center axis of the cartridge, on the periphery of the end piece wall 202. It is anticipated that the inlet and outlet fittings 220 and 224 may be reversed, or otherwise arranged. That is, the particular configuration of treatment material (not shown) may dictate the placement of the fittings 220 and 224 in any of several configurations. Each fitting 220 and 224 has a longitudinal axis 204 and 207, respectively. The longitudinal axis 204 and 207 of the fittings 220 and 224 may lie together in only one plane. Also, the solid protrusion 226 may have a cylindrical end (preferably having a length from about 0.1 cm, about 0.3 cm, about 0.5 cm to about 1 cm, about 1.5 cm, about 2 cm, and preferably having a diameter from about 0.1 cm, about 0.2 cm, about 0.3 cm to about 0.5 cm, about 0.7 cm, about 1 cm) extends from near the edge of the end piece wall 202, adjacent to the connection of the head 200 and the cartridge. The protrusion 226 has a longitudinal axis 228. The longitudinal axis 204 of the inlet fitting 220, the longitudinal axis 207 of the outlet fitting 224, the longitudinal axis 228 of the protrusion 226, and the longitudinal axis 210 of the cartridge may be parallel with a line of cartridge insertion 206 into the head assembly. Further, the protrusion 226 is positioned, relative to a side view along the line of insertion 206 of the head 200, between the inlet fitting 220 and the outlet fitting 224 (i.e., no part of the protrusion end 227 exceeds the outer most portion of the inlet or outlet fittings 220 or 224). As shown, the distance L1 (preferably from about 0.2 cm, about 0.5 cm, about 0.8 cm to about 2 cm, about 4 cm, about 5 cm) from the longitudinal axis 204 of the inlet fitting 220 to the longitudinal axis 207 of the outlet fitting 224 is less than the distance L2 (preferably from about 0.5 cm, about 0.7 cm, about 1 cm, about 2 to about 3 cm, about 5 cm, about 6 cm) from the longitudinal axis 204 of the inlet fitting 220 to the longitudinal axis 228 of the protrusion 226. Further, as shown, the distance L2 from the longitudinal axis 204 of the inlet fitting 220 to the longitudinal axis 228 of the protrusion 226 is less than the distance L3 (preferably from about 0.7 cm, about 1 cm, about 1.5 cm, about 2 to about 3 cm, about 6 cm, about 7 cm) from the longitudinal axis 207 of the outlet fitting 224 to the longitudinal axis 228 of the protrusion 226. As mentioned above, the inlet and outlet fittings 220 and 224 may be reversed or otherwise arranged, such that the distance L2 would be greater than the distance L3.

The protrusion 226 extends approximately one half the distance of the fittings 220 and 224 from the end piece wall 202. It is the positioning of the protrusion 226 on the head 200 that allows for the protrusion 226 to be rigidly supported by a support bridge 230. While the protrusion 226 may be solid, it is anticipated that the protrusion 226 may also be entirely or partially hollow. The size and possibilities of different arrangements of the inlet and outlet fittings 220 and 224 and the protrusion 226 contribute to the compactness of the head assembly. An outwardly biased latch 212 is disposed on the outer surface of the hollow housing 208 just before the second end. The latch 212 is capable of being releasably engaged by an appliance, as described in more detail below. As shown, opposite the latch 212, on the outer surface of the hollow housing 208 are two guide rails 222 which run along the longitudinal axis 210 of the cartridge approximately one quarter the length of the cartridge. A treatment material (not shown) is disposed within the interior space of the housing 208 and is in fluid communication with the inlet fitting 220 and the outlet fitting 224.

The inlet fitting 220 of the head 200 will now be described in detail. Since the inlet fitting 220 and the outlet fitting 224 can be similarly configured, only the inlet fitting 220 will be described herein. However, it is understood that the same description may be equally applicable to the outlet fitting 224. The inlet fitting 220 (preferably having a length from about 1.5 cm, about 2 cm, about 2.5 cm to about 3 cm, about 4 cm, about 5 cm) extends outwardly away from the end piece wall 202 and is cylindrically shaped (preferably having an inside diameter from about 0.3 cm, about 0.5 cm, about 0.6 cm to about 1 cm, about 1.2 cm, about 1.5 cm, and preferably having an outside diameter from about 0.5 cm, about 0.8 cm, about 1 cm to about 1.5 cm, about 1.8 cm, about 2 cm) at its proximal end 216 adjacent the end piece wall 202. A channel 234 runs the length of the inlet fitting 220. The channel 234 meets the cartridge housing 208 such that the inlet fitting 220 is in fluid communication with the interior space of the hollow cartridge housing 208 and thus the treatment material (not shown). The channel 234 has an opening (preferably having a diameter from about 0.3 cm, about 0.5 cm, about 0.6 cm to about 1 cm, about 1.3 cm, about 1.5 cm) and an open portion (as used herein, the term “open portion” refers to the portion of a fitting which remains after a portion of it has been cut away and such portion would have, if not cut away, continued to form and define the fitting) 244 (preferably having a length from about 0.5 cm, about 0.8 cm, about 1 cm to about 2 cm, about 3 cm, about 4 cm, and preferably having a height from about 0.1 cm, about 0.3 cm, about 0.5 cm to about 1 cm, about 1.5 cm, about 2 cm, and preferably having a width from about 0.4 cm, about 0.7 cm, about 1 cm to about 1.5 cm, about 2.5 cm, about 3 cm) at the distal end 218 of the fitting 220. The open portion 244 is adjacent the protrusion 226, and permits water to easily flow from and to the opening. The channel 234 is exposed at the open portion 244. An o-ring 232 (preferably having an outside diameter from about 0.5 cm, about 0.8 cm, about 1 cm to about 2 cm, about 3 cm, about 4 cm) encircles the inlet fitting 220 and is placed adjacent the open portion 244, between the open portion 244 and the proximal end 216 of the inlet fitting 220. An actuation wall 236 (preferably having a length from about 0.4 cm, about 0.7 cm, about 1 cm to about 2 cm, about 2.5 cm, about 3 cm) extends away from the base 238 of the channel 234 of the inlet fitting 220 running along the direction of the longitudinal axis 204 of the inlet fitting 220. The actuation wall 236 has a flat portion 240 (preferably having a length from about 0.1 cm, about 0.4 cm, about 0.6 cm to about 1.5 cm, about 2 cm, about 3 cm, and preferably having a height from about 0.1 cm, about 0.2 cm, about 0.4 cm to about 1 cm, about 2 cm, about 3 cm, and preferably having a width from about 0.05 cm, about 0.1 cm, about 0.15 cm to about 0.3 cm, about 0.5 cm, about 1 cm) and an angled portion 242 (preferably having a length from about 0.1 cm, about 0.2 cm, about 0.4 cm to about 1 cm, about 2 cm, about 3 cm, and preferably having a height, at its highest point, from about 0.1 cm, about 0.2 cm, about 0.4 cm to about 1 cm, about 1.5 cm, about 2 cm, and preferably having a height, at its lowest point, from about 0 cm, about 0.1 cm, about 0.2 cm to about 0.5 cm, about 1 cm, about 1.5 cm, and preferably having a width from about 0.05 cm, about 0.08 cm, about 0.15 cm to about 0.25 cm, about 0.5 cm, about 1 cm) between the flat portion 240 and a leading portion 248 (preferably having a height from about 0 cm, about 0.1 cm, about 0.2 cm to about 0.5 cm, about 1 cm, about 1.5 cm, and preferably having a width from about 0.05 cm, about 0.1 cm, about 0.15 cm to about 0.5 cm, about 0.8 cm, about 1 cm) of the actuation wall 236.

The sum of the leading portion 248, the angled portion 242, and the flat portion 240 together, in this embodiment, form a cam surface which engages a follower, a described hereafter. The surface may include more or less surfaces which physically touch a follower for the purpose of actuation. These surfaces may or may not be continuous. In the preferred embodiment, each of the three surfaces (leading portion 248, angled portion 242, and the flat portion 240) have different functions, as discussed more fully hereafter. However, a cam surface, as defined by this invention, may optionally include a surface having multiple functions to actuate a valve. For instance, the same surface may move a follower, opening a valve, and also hold the follower in place, so that the valve stays open. Also, it should be pointed out that the cam surface of the actuation wall 236 may be angled and/or vectored in relation to the longitudinal axis 204 of the inlet fitting 220, the longitudinal axis 207 of the outlet fitting 224, the longitudinal axis 228 of the protrusion 226, the longitudinal axis 210 of the cartridge, and/or the line of insertion 206 of the cartridge, as discussed more fully hereafter. As shown in FIG. 11B, the angled portion 242 of the cam surface is illustrated with an essentially straight surface which is angled approximately 45 degrees relative to the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge. As is apparent from FIG. 11B, angled portion 242 has a vector 203 which has a radial component which extends approximately 45 degrees from the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge. Since the vector 203 of the angled portion 242 has a radial component in relation to the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge, the angled portion 242 of the cam surface is vectored. That is, the angled portion 242 radially faces away from the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge approximately 45 degrees. Further, as shown in FIG. 11B, the flat portion 240 of the cam surface is illustrated with an essentially straight surface which is essentially not angled (that is, essentially parallel) relative to the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge. As is apparent from FIG. 11B, flat portion 240 has a vector 205 having a radial component which extends approximately 90 degrees from the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge. Since the vector 205 of the flat portion 240 has a radial component in relation to one or more of the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge, the flat portion 240 of the cam surface is vectored. That is, the flat portion 240 radially faces away from the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge approximately 90 degrees. Further, since the vector 205 of the flat portion 240 is essentially radial only, the flat portion 240 is fully vectored.

The cam surface of the actuation wall 236 contributes to the compactness and mechanical advantage of the invention, each of which is discussed more fully hereafter. The height of the actuation wall 236 is less than the inside diameter of the channel 234 of the inlet fitting 220 in order to provide a less obstructed channel 234 for the fluid to enter. The opening permits a fluid to pass through the channel 234 of the inlet fitting 220 and enter the interior space of the cartridge housing 208. The channel 234 is aligned with the longitudinal axis 210 of the cartridge so that the fluid entering the opening of the inlet fitting 220 flows in a direction of the longitudinal axis 210 of the cartridge housing 208 through the channel 234.

For the purpose of further describing one embodiment, but not for the purpose of limitation, and as shown in FIG. 11C, the most distal portion of the protrusion end 227 to the most proximal portion of the inlet fitting 220 is preferably a distance (L9) from about 0.5 cm, about 0.7 cm, about 1 cm to about 1.5 cm, about 2 cm, about 2.5 cm, and the most distal portion of the protrusion end 227 to the most distal portion of the inlet fitting 220 is preferably a distance (L4 through L8) from about 1 cm, about 2 cm, about 2.5 cm to about 4 cm, about 4.5 cm, about 5 cm. The most distal portion of the protrusion end 227 to the most proximal portion of the open portion 244 is preferably a distance (L8) from about 0.5 cm, about 1 cm, about 1.5 cm to about 3 cm, about 4 cm, about 5 cm, and the most distal portion of the protrusion end 227 to the most distal portion of the open portion 244 is preferably a distance (L4 through L8) from about 1 cm, about 2 cm, about 2.5 cm to about 4 cm, about 4.5 cm, about 5 cm. The most distal portion of the protrusion end 227 to the most proximal portion of the actuation wall 236 is preferably a distance (L8) from about 0.5 cm, about 1 cm, about 1.5 cm to about 3 cm, about 4 cm, about 5 cm, and the most distal portion of the protrusion end 227 to the most distal portion of the actuating wall 236 is preferably a distance (L4 through L8) from about 1 cm, about 2 cm, about 2.5 cm to about 4 cm, about 4.5 cm, about 5 cm. The most distal portion of the protrusion end 227 to the most proximal portion of the flat portion 240 is preferably a distance (L7 through L8) from about 1 cm, about 1.5 cm, about 2 cm to about 3 cm, about 4 cm, about 5 cm, and the most distal portion of the protrusion end 227 to the most distal portion of the flat portion 240 is preferably a distance (L6 through L8) from about 1 cm, about 1.5 cm, about 2 cm to about 3 cm, about 4 cm, about 5 cm. The most distal portion of the protrusion end 227 to the most proximal portion of the angled portion 242 is preferably a distance (L6 through L8) from about 1 cm, about 1.5 cm, about 2 cm to about 3 cm, about 4 cm, about 5 cm, and the most distal portion of the protrusion end 227 to the most distal portion of the angled portion 242 is preferably a distance (L5 through L8) from about 1.5 cm, about 2 cm, about 2.5 cm to about 4 cm, about 4.5 cm, about 5 cm. The most distal portion of the protrusion end 227 to the leading portion 248 is preferably a distance (L5 through L8) from about 1.5 cm, about 2 cm, about 2.5 cm to about 4 cm, about 4.5 cm, about 5 cm.

While the length of the inlet fitting 220 preferably has a length from about 0.5 cm, about 0.8 cm, about 1 cm to about 4 cm, about 6 cm, about 7 cm, it may be at least about 0.5 cm and greater, without limitation, because it is application of this invention which dictates size, and such application may be residential or industrial. The same is true for any physical feature of this invention, including, but not limited to, the channel 234 of the inlet fitting 220, outlet fitting 224, protrusion 226, the opening, the open portion 244, the o-ring 232, the actuating wall 236, the cam surface, etc.

Further regarding the inlet fitting 220, it should be understood that the inlet fitting 220 may be various lengths for purposes which include controlling the timing of valve actuation. Also, the inlet fitting 220 may be various diameters for reasons which include ensuring that the inlet fitting 220 is placed into the correct receiving port housing. The inlet fitting 220 need not be circular as the inlet fitting 220 may be any number of various dimensions. Regarding the actuation wall 236 of the inlet fitting 220, the actuation wall 236 height may exceed the inside diameter of the channel 234 of the inlet fitting 220 or, as previously described, the height may be less than the inside diameter channel 234 of the fitting 220. Additionally, the actuation wall 236 may exceed the length of the channel 234 or may occupy only the distal end 218 of the inlet fitting 220. However, it should be understood that there should be enough actuation wall 236, and more particularly, cam surface, both in height, length, and width, to actuate a valve. Additionally, regarding the open portion 244 in relation to the actuation wall 236, the open portion 244 may be more open than closed, or may be more closed than open. However, it should be understood that enough of the actuation wall 236 should be exposed by the open portion 244 so that physical contact between the follower and the cam surface of the actuation wall 236 can occur to facilitate actuation of the valve. Alternatively, the actuation wall 236 may extend from the outside of the inlet fitting 220 instead of from the base 238 the channel 234 of the inlet fitting 220, eliminating a need for an open portion 244. The cam surface of the actuation wall 236 may be angled in relation to the longitudinal axis 204 of the inlet fitting 220, the longitudinal axis 207 of the outlet fitting 224, the longitudinal axis 228 of the protrusion 226, and/or the longitudinal axis 210 of the cartridge (preferably having an angle from about 1 degree, about 10 degrees, about 15 degrees, to about 40 degrees, about 60 degrees, about 90 degrees). Also, the cam surface of the actuation wall 236 may be vectored in relation to one or more of the longitudinal axis 204 of the inlet fitting 220, the longitudinal axis 207 of the outlet fitting 224, the longitudinal axis 228 of the protrusion 226, and/or the longitudinal axis 210 of the cartridge (preferably vectored from about 1 degree, about 10 degrees about 15 degrees, to about 40 degrees, about 60 degrees, about 90 degrees) such that cam surface, or portion thereof, may be partially or fully vectored. In the preferred embodiment, width and length of the angled portion 242 of the actuation wall 236, between the leading portion 248 and the flat portion 240, may vary, as well as the degree which the angled portion 242 is angled and/or vectored from the longitudinal axis 204 of the inlet fitting 220, the longitudinal axis 207 of the outlet fitting 224, the longitudinal axis 228 of the protrusion 226, the longitudinal axis 210 of the cartridge, and/or the line of insertion 206, as long as the cam surface of the actuation wall 236 adequately contacts a follower to facilitate actuation of a valve in an essentially orthogonal actuation motion relative to the longitudinal axis 204 of the inlet fitting 220, the longitudinal axis 207 of the outlet fitting 224, the longitudinal axis 228 of the protrusion 226, the longitudinal axis 210 of the cartridge, and/or the line of insertion 206.

As mentioned earlier, the cam surface of the actuation wall 236 contributes to the compactness of the head assembly. That is, the essentially orthogonal actuation motion caused by the cam surface of the actuation wall 236 allows for inlet and outlet passageway housings and inlet and outlet valves to be positioned essentially perpendicular to the line of insertion 206 of the cartridge. Such positioning allows for a head assembly to be shorter in length (the distance in-line with the line of insertion 206 of the cartridge) because a head assembly needs only to be a length sufficient to accommodate receiving port housings (e.g., outlet fitting and inlet fitting receiving port housings) which contain only a portion of a follower. Receiving port housings (e.g., outlet fitting and inlet fitting receiving port housings) can be much shorter in length than a valve (e.g., inlet and outlet valves). Thus, the result of positioning of valves, passageway housings, and the port housings allows for a longer cartridge per fixed distance. Thus, when the compact orientation of a head assembly is discussed, it should be kept in mind that the cam surface of the actuation wall 236 is responsible, in part, for allowing the particular orientation of a head assembly.

In some embodiments, and as illustrated in FIG. 11D, projecting along the top and/or bottom faces of the head are a plurality of fins 250, structured to matingly engage with the manifold portion to which the head is coupled.

FIGS. 12A and 12B illustrate perspective views of a head, in accordance with an embodiment of the invention. FIG. 12C illustrates a cross-section view of a head, in accordance with the embodiment of FIGS. 12A-12B. As shown in FIGS. 12A-12C, cartridge top member 251 may include member body 252. Member body 252 may have a margin 254 from which exterior helical tabs 258 operatively connect with interior helical tabs of a cartridge receiver. As with the interior helical tabs, exterior helical tabs 258 may spiral upward at an approximate 8 degree angle along margin 254 to a position less than half the circumference away from their point of origin. The underside surface 284 of these tabs may be supported by a top surface of the interior helical tabs of the manifold assembly. Exterior helical tabs 258 may have at their end points ramps 276 for facilitating engagement with interior helical tabs.

Cartridge top member body 252 may have defined therein interior receiver well 260 with inside margin 254 for sealing with O-ring of the manifold assembly. This effects a fluid seal between unfiltered inlet water within receiver well 260 and the cavity of the manifold assembly body.

As illustrated in FIG. 12A-12C, a plurality of inlet orifices 268 may be formed within the bottom surface of receiver well 260. These orifices 268 may be spaced circumferentially and equidistant from each other, although other spacing and numbers of orifices can be used, as would be understood by one skilled in the art. A distinct feature of these orifices 268 is that the inside diameter of any individual orifice is designed such that the adhesive forces between the inside surface and any remaining water within that orifice may allow for capillary action to prevent dripping when the cartridge assembly is disengaged from the manifold assembly. These orifices 268 may direct inlet water to cartridge housing.

Outlet bore 278 may be bored through the center of cartridge top member 251. Within outlet bore 278 reduced body portion of cartridge insert may be engaged for conveyance of filtered water. A lip 280 may protrude from the underside of outlet bore 278, providing proper positioning of filter within cartridge assembly. Dual ramps 256 may extend upward from the bottom of receiver well 260. One or the other of the ramps 256 may radially align with high-flow valve contact surface to compress and open the valve when cartridge top member 251 is rotatably moved into place to operatively connect with manifold assembly.

The underside surface 284 of each helical tab 258 may have a locking tab 262 for operatively connecting with a cooperative depression located in the interior helical tab of manifold assembly. As will be seen, these locking tabs 262 may interface with the depressions during engagement of the cartridge assembly with the manifold assembly to lock the cartridge assembly in place and to provide a degree of burst protection to the components of filter assembly, i.e. to resist unexpected disconnection of the cartridge assembly from the manifold assembly. The locking tabs 262 may disengage from the respective depressions permitting the cartridge assembly to back off from manifold assembly at a predefined level of hydraulic pressure for the benign disengagement thereof.

Without locking tabs 262, normal pressure levels of the incoming water service and associated vibrations would slowly cause the cartridge assembly to disconnect from manifold assembly, resulting in leakage and the eventual total disengagement of the cartridge assembly from the manifold assembly. One unique feature, among others, of locking tabs 262 in the representative embodiment of the Figures, is that they can be designed such that they do not allow for this gradual disconnecting of the filter assembly under normal line pressure conditions and within normal line pressure tolerances, but will commence disconnecting at a certain pressure condition below the structural strength limits of the filter assembly. Generally, normal line pressure conditions range from about 20 psig to about 120 psig. In this representative embodiment and in other representative embodiments such as those described below, the filters can be designed to disconnect at pressures above about 120 psig, and in other presently preferred embodiments at pressures above a value from about 150 psig to about 180 psig. A person of ordinary skill in the art will recognize that additional ranges of pressure values within these explicit pressure ranges are contemplated and are within the present disclosure. The design of the locking tabs 262 may determine this pressure condition by being a more aggressive design, such as with deeper depressions, or a less aggressive design, such as with shallower depressions, a more aggressive design seating more firmly in the depression and requiring greater pressure relative to less aggressive designs to unseat the locking tabs 262 from the depressions.

As illustrated in FIG. 12B, the cartridge top member 251, has a surface 270 extending circumferentially from body 252. The interior face 272 of surface 270 may progressively slope centerward to inlet orifices 268. This slope allows for a smoother transition and flow pattern from the interior space within surface 270. Also, on the interior face 272 may be two weld facilitators 274. The weld facilitators 274 may be diametrically opposed from each other.

As illustrated in FIGS. 12A and 12C, defined around the perimeter of upper sealing surface 266 of receiver well 260 may be a plurality of vent ports 264. Vent ports 264 may be spaced equidistant around the diameter of sealing surface 266. These vent ports 264 may separate the surface 266 from the interior cavity of the manifold assembly body, as shown in FIG. 1. As will be seen, these vent ports 264 may allow for relief of pressure trapped in the cartridge assembly before complete disengagement during the disassembly of the cartridge assembly from manifold assembly. The top edge 282 of receiver well 260 may be chamfered to facilitate this relief of pressure.

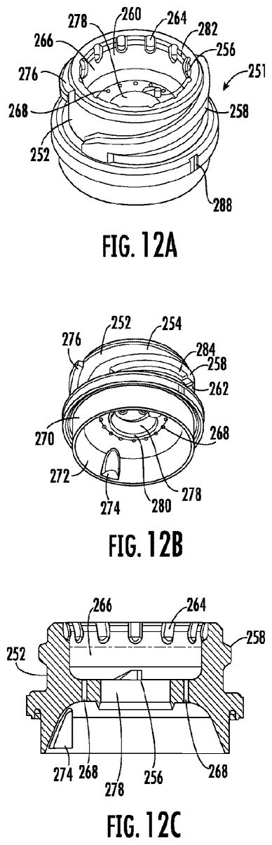

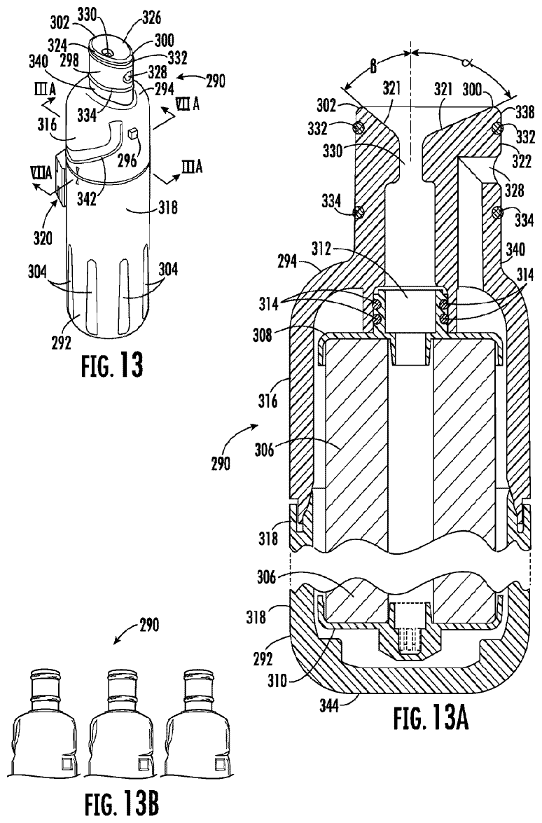

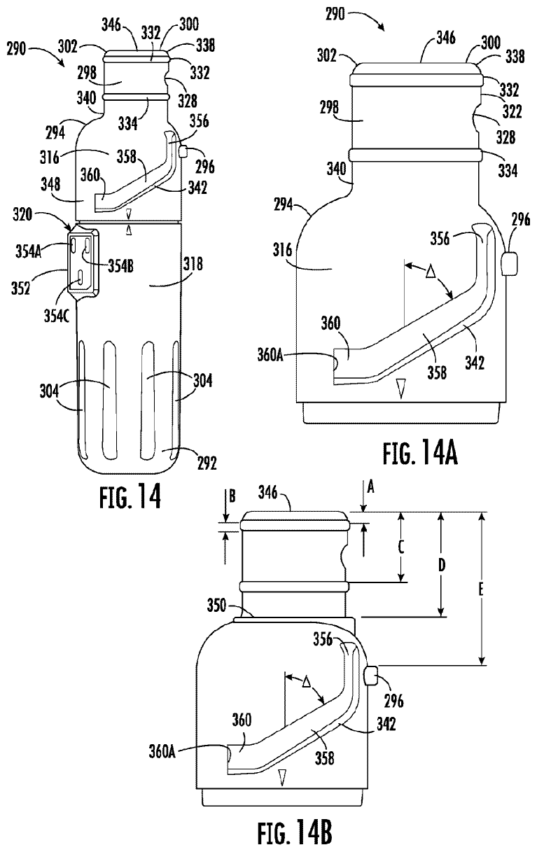

FIGS. 13-14B illustrate perspective views and cross-section views of a head, in accordance with an embodiment of the invention. As shown in FIGS. 13-14B, the body portion 348 of the filter unit 290 includes a cylinder-like construction having a diameter that is easily graspable by the hand of a user. A multitude of grasping cutouts 304 are disposed on the body portion 348 and extend toward the distal end of the body portion 348 and are designed to provide a gripping surface for a user to both engage and disengage the filter unit 290 from the filter head assembly. As disclosed in further detail herein, engagement of the filter unit 290 typically includes rotational and longitudinal movement of the filter unit 290 relative to the filter head assembly. The end cap 308 includes an outlet 312 that relays filtered water out of the filtering media 306 after the water has been filtered. Seals 314 prevent cross-contamination of unfiltered water with filtered water that has passed through the filtering media 306. As shown in FIG. 14B, the distance A from a distal protrusion surface 346 of the filter unit 290 to a first seal 322 is approximately 2.69 millimeters. The first seal 322 and a second seal 334 have a thickness B of approximately 2.62 millimeters. The distance C between the distal protrusion surface 346 and the second seal 334 is approximately 18.69 millimeters, while the distance D from the distal protrusion surface 346 to a shoulder support 350 is approximately 28.30 millimeters. Finally, the distance E from the distal protrusion surface 346 to the laterally extending key member 296 is approximately 41.20 millimeters. The dimensions noted above are specifically configured to complement and interact with the filter head assembly, thereby allowing for tight and secure engagement of the filter unit 290 with the filter head assembly.

The engagement protrusion 298 is centrally aligned as viewed from the front. However, the engagement protrusion 298 is offset as viewed from the side. Thus, the engagement protrusion 298 is generally disposed in an offset position on the proximal end of the filter unit 290. Further, the outlet 332 is generally aligned with a central longitudinal axis that extends longitudinally through the center of the filter unit 290. The laterally extending key member 296 can be constructed in a variety of shapes. For example, the laterally extending key member can include a rectangular shape, a cylindrical shape, or any other shape adapted to interface with the key slot. Regardless of the shape, the laterally extending key member 296 generally has a width of approximately 2.75 millimeters, a height of approximately 2.75 millimeters, and extends approximately 27.73 millimeters from the central longitudinal axis.

The body portion 348 of the filter unit 290 is defined by a forward casing 316 and a rearward casing 318 that are placed in abutting engagement over the water filter disposed inside the filter unit 290. The forward casing 316 may be attached to the rearward casing 318 in any known manner, such as by heat staking, welding, or mechanical fastener attachment. Alternatively, it is contemplated that the body portion 348 could include one integral casing formed from a single part. The engagement protrusion 298 extends from the proximal end 294 of the filter unit 290 and is smaller in cross-sectional area than the body portion 348 of the filter unit 290. The body portion 348 tapers gradually from the proximal end 294 to the distal end 292.

Referring to FIG. 13A, an engagement or end wall 321 of the engagement protrusion 298 is integral with a sidewall 332 of the engagement protrusion 298 and has a concave construction that tapers downwardly to an end aperture, which constitutes an outlet 330 of the filter unit 290. A side aperture, which constitutes an inlet 328, is positioned in the sidewall 332 of the engagement protrusion 298. For purposes of description, as viewed in FIG. 13A, the filter unit 290 is described in an upright position, wherein the longitudinal axis of the filter unit 290 is in a substantially vertical orientation. In the illustrated embodiment, an angle α2 of the engagement wall 321 adjacent to the first portion 300 has an angle approximately 67.7 degrees from vertical. It is contemplated that the angle α2 could be as low as 15 degrees or as high as 90 degrees. An angle α1 of the engagement wall 321 of the engagement protrusion 298 at the second portion 302 of the engagement protrusion 298 is approximately 51 degrees, although it is contemplated that the angle α1 could be as low as 5 degrees or as high as 85 degrees. It will be noted that the degrees and constructions of the engagement wall 321 may vary from these specified angles and still be within the scope of the present invention. The angle θ of the engagement wall 321 in the engagement protrusion 298 is approximately 46.9 degrees from vertical on both third and fourth portions 324, 326 of the engagement protrusion 298. It is contemplated that the angle θ could be as low as 10 degrees or as high as 85 degrees. As illustrated, the first and second portions 300, 302 of the engagement protrusion 298 are not symmetrical, while the third and fourth portions 324, 326 of the engagement protrusion 298 are generally symmetrical.

Referring again to the embodiments of FIG. 13A, the inlet 328 and the outlet 330 of the filter unit 290 have approximately the same diameter to dissipate extreme water pressure increases or decreases in the system. Nevertheless, it is contemplated that the diameter size of the inlet 328 and the outlet 330 could differ. Additionally, the engagement protrusion 298 includes first and second seals 322, 334, wherein the first seal 322 is disposed above the inlet 328 near a forward edge 338 of the engagement protrusion 298, and the second seal 334 is disposed between the inlet 328 and a base portion 340 of the engagement protrusion 298. Both the first and second seals 322, 334 extend around the sidewall 332 of the engagement protrusion 298. The first seal 322 keeps incoming unfiltered water entering the inlet 328 from cross-contaminating with exiting filtered water leaving the outlet 330. Therefore, the first seal 322 acts as a barrier, keeping the water to be filtered separate from the filtered water. The second seal 334 acts as a barrier that prevents filtered water from leaking around the body portion 348 during use.

Referring now to FIG. 14, a shoulder on the proximal end 294 of the filter unit 290 includes the laterally extending key member 296, which is adapted to interface with and disengage an interference member disposed in the filter head assembly, as outlined in further detail herein. The laterally extending key member 296, as illustrated, includes a square shape. The laterally extending key member 296 may extend out from the body portion 348 approximately 0.5 to 10 mm. In the illustrated embodiment, the laterally extending key member 296 extends out from the body portion 348 approximately 2.75 mm. However, it is contemplated that the shape of the laterally extending key member 296 could also be circular, oval, polygonal, etc. The laterally extending key member 296 includes a profile height that is adapted to be received in a key slot inside the filter head assembly. The key slot includes three segments that define the key slot shape. A first segment is substantially linear and parallel with the longitudinal extent of the filter head assembly. A second segment extends at an angel between 0 degrees and 98 degrees relative to the longitudinal extent of the filter head assembly. A third segment extends substantially laterally or normal to the longitudinal extent of the filter head assembly. The third segment may angle back 0 degrees to 25 degrees to provide a detent-type configuration that is adapted to secure the laterally extending key member 296 in place in the key slot of the filter head assembly. A retention nub may be disposed in the third segment to assist in securing the laterally extending key member 296 in place. As shown in the illustrated embodiment, the engagement protrusion 298 may include a straight walled construction designed to engage the manifold and be received in a manifold. The engagement surface 342 are disposed on the filter unit on opposite sides thereof. The illustrated embodiment depicts the engagement surface 342 in the form of channeled grooves. However, it is contemplated that the engagement surface 342 could be formed from externally protruding walls, or a combination of grooves and externally protruding walls, among other possible constructions. Similar to the laterally extending key member 296, the engagement surface 342 is shown having a square shape. However, it is contemplated that the square shape of the engagement surface 342 could also be circular, oval, polygonal, etc. Similar to the key slot, the engagement surface 342 includes three segments. Specifically, each of the engagement surface 342 includes a first segment 356 that is substantially linear and parallel with the longitudinal extent of the body portion of the filter unit. A second segment 358 of the engagement surface 342 extends at an angle between 0 degrees and 342 degrees relative to the longitudinal extent of the body portion of the filter unit. In the illustrated embodiment, the angle A of the second segment 358 of the engagement surface 342 is 62 degrees from vertical. A third segment 360 of the engagement surface 342 extends substantially laterally or normal to the longitudinal extent of the body portion of the filter unit. Alternatively, the third segment 360 may angle back 0 degrees to 25 degrees to provide a detent-type configuration that is adapted to secure the first and second guides in place after engagement of the filter unit with the manifold. Each of the first, second, and third segments 356, 358, and 360 of the engagement surface 342 provide a smooth engagement of the filter unit with the manifold during installation of the filter unit.

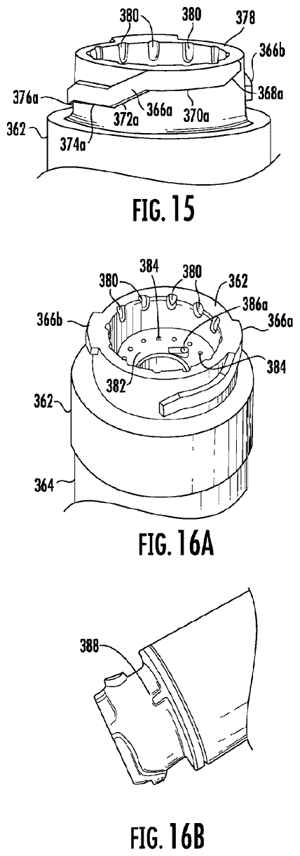

FIGS. 15-16B illustrate perspective views of a head, in accordance with an embodiment of the invention. As shown in FIGS. 15-16B, a filter cartridge comprises a filter cap 362, a filter media and a filter body 364 is illustrated in which the filter cartridge can be used to compete a two stage engagement structure. The filter media can comprise a wide variety of filtering medias for example depth filtration media, surface filtration media, sand filtration media, activated carbon filtration media, ion exchange filtration media, cross-flow membrane filtration media and hollow fiber filtration media. Filter cap 362 and filter body 364 can be fabricated of suitable polymeric materials such as polypropylene, polycarbonate or polyethylene. Alternatively, the filter cartridge can be fabricated from modified polyolefins such as, for example, metallocene modified polypropylene or polyethylene polymers and copolymers as well as either high or low density polyethylene polymers, having advantageous properties such as increased strength, elasticity or increased ultimate elongation percentages such as disclosed in U.S. patent application Ser. No. 10/377,022, published as U.S. Pat. Pub. No. 2004/0094468 A1, which is herein incorporated by reference to the extent not inconsistent with the present disclosure. In some embodiments, filter cap 362 may be constructed of a first polymer, such as polypropylene, having a specific quality such as, for example, strength or rigidity while filter body 364 is constructed of a second polymer having a different design quality such as, for example, increased ultimate elongation percentage or increased stretch, with suitable polymers being metallocene modified polypropylene or polyethylene polymers and copolymers as well as either high or low density polyethylene polymers. Filter cap 362 and filter body 364 are operatively joined using any suitable joining technique such as, for example, an engageable thread or other alternative joining techniques such as adhesives, heat welding, spin welding, ultrasonic welding and the Like. The filter cartridge generally comprises an attachment end and a handling end.

Filter cap 362 can comprise a pair of opposed and identically configured multi-stage filter attachment members 366a, 366b. As clearly illustrated in FIGS. 15-16B, multi-stage filter attachment member 366a can comprise a first angled portion 368a adjacent to the first horizontal portion, a first horizontal portion 370a facing toward the filter body, a second angled portion 372a adjacent to the first horizontal portion, a second horizontal portion 374a facing toward the filter body, and a third angled portion 376a adjacent to the second horizontal portion while correspondingly, multi-stage filter attachment member 366b can comprise a first angled portion 368b, a first horizontal portion 370b, a second angled portion 372b, a second horizontal portion 374b and a third angled portion 376b.

As clearly illustrated in FIGS. 15-16B, filter cap 362 comprises a projecting insertion wall 378. A plurality of venting notches 380 is spaced about the inner rim of the insertion wall 378, although a single vent or a different number of venting notches can be used relative to the venting notches shown in the Figures. Filter cap 362 further comprises an interface surface 382 having a plurality of feed throughbores 384 and a return throughbore 328. As illustrated, interface surface 382 can further comprise a pair of arcuate kick-off ramps 386a, 386b. Moreover, as illustrated in FIG. 16B, filter cap 362 may comprise a notch 388 at the base of the insertion wall 378, the notch 388 sized to engage with a corresponding notch within the manifold in which the filter cap 362 is installed.

The head 206 of the reusable water filter cartridge may also have numerous other embodiments, with elements as will be described with respect to FIGS. 17-24 henceforth.

FIG. 17 illustrates a perspective view of a head, in accordance with an embodiment of the invention. As shown in FIG. 17, the head may include a plurality of tabs 390, which are positioned adjacent the first end of the head and extend radially outwards. The tabs 390 are structured to matingly engage with corresponding apertures in the manifold.

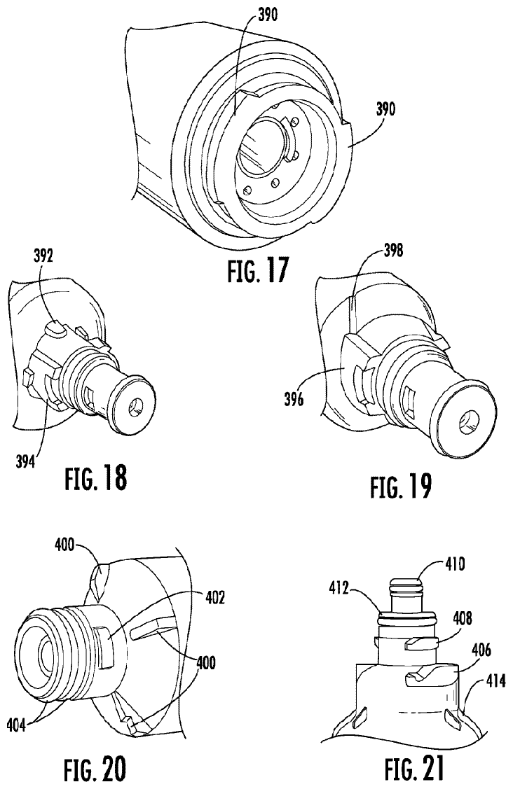

FIG. 18 illustrates a perspective view of a head, in accordance with an embodiment of the invention. As shown in FIG. 18, the head may include at least one rib 392, the at least one rib 392 structured to extend between a cylindrical portion in the axial direction of the head and an adjacent face of the head extending in a primarily orthogonal direction from the cylindrical portion. The rib 392 may provide additional structural support and/or matingly engage with corresponding features or apertures in the manifold. Moreover, the head may also include a key 394 extending radially outward along the cylindrical portion of the head, structured to matingly engage with corresponding tabs or slots of the manifold.

FIG. 19 illustrates a perspective view of a head, in accordance with an embodiment of the invention. As shown in FIG. 19, the head may include a key 396 extending radially outward along the cylindrical portion of the head, structured to matingly engage with corresponding tabs or slots of the manifold. Moreover, the head may include at least one fin 398 at the base of the head, extending towards the first end of the head.

FIG. 20 illustrates a perspective view of a head, in accordance with an embodiment of the invention. As shown in FIG. 20, the base portion of the head may include a plurality of fins 400, the fins 400 extending towards the first end of the head. The head may also include a key 402 extending radially outward along the cylindrical portion of the head, structured to matingly engage with corresponding tabs or slots of the manifold. In the embodiment illustrated in FIG. 20, the cylindrical portion of the head also includes seals 404, the seals 404 structures to prevent fluid from the inlet and outlet portions of the head from leaking into the appliance and/or the manifold.

FIG. 21 illustrates a perspective view of a head, in accordance with an embodiment of the invention. As shown in FIG. 21, the base portion of the head may include a plurality of fins 414, the fins 414 extending towards the first end of the head. The head may include a first cylindrical portion at the first end of the head, and an adjacent second cylindrical portion, the second cylindrical portion having a larger diameter than the first cylindrical portion. Extending radially outwards from the perimeter of the first cylindrical portion may be at least one first key 408, and extending radially outwards from the second cylindrical portion may be at least one second key 406. The first and second keys 408, 406 may be structured to matingly engage with corresponding apertures and/or slots of the manifold. Proximate the first end of the head and adjacent the first cylindrical portion is a substantially cylindrical tip, structured with a first seal 410. The first seal 410 is positioned along the perimeter of the tip. Proximate the first cylindrical portion is a second seal 412, positioned along the perimeter of the first cylindrical portion. An inlet or an outlet of the head may be positioned between the first and second seals 410, 412, such that the first and second seals 410, 412 prevent fluid from the inlet or outlet from reaching areas of the manifold other than that which is between the first and second seals 410, 412.

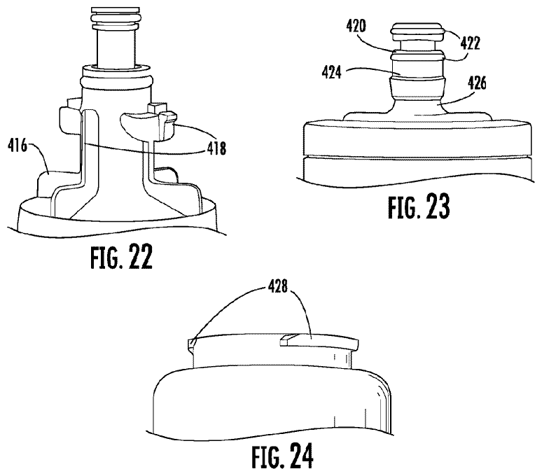

FIG. 22 illustrates a perspective view of a head, in accordance with an embodiment of the invention. As shown in FIG. 22, the head may comprise a plurality of protrusions 418 extending radially outward from a first cylindrical portion of the head, such as to matingly engage with corresponding apertures or slots in the manifold. Moreover, the head may include at least one rib 416, the at least one rib 416 structured to extend between the first cylindrical portion in the axial direction of the head and an adjacent base of the head extending in a primarily orthogonal direction from the cylindrical portion.

FIG. 23 illustrates a perspective view of a head, in accordance with an embodiment of the invention. As shown in FIG. 23, the head may include a first cylindrical portion 426 adjacent the base of the head, extending towards a first end of the head. The head may also include a second cylindrical portion 424 adjacent the first cylindrical portion 426, and a third cylindrical portion 420 adjacent the second cylindrical portion 424. In the embodiment shown in FIG. 23, the first cylindrical portion 426 and the third cylindrical portion 420 are smaller in diameter than the second cylindrical portion 424. Positioned on the first end of the second cylindrical portion 424 and the first end of the third cylindrical portion 420 are seals 422, the seals 422 structured to extend around the perimeter of the second and third cylindrical portions 424, 420, and having a substantially similar diameter.

FIG. 24 illustrates a perspective view of a head, in accordance with an embodiment of the invention. As shown in FIG. 24, the head may include a plurality of fins 428 extending radially outwards from a cylindrical portion of the head, the fins 428 structured to matingly engage with corresponding apertures or slots of the manifold in which the head of the reusable water filter cartridge is positioned.

FIG. 25 illustrates an exploded view of a water filter cartridge 430, in accordance with an embodiment of the invention. Water filter cartridge 430 may include a filter housing 444, and a head 432 coupled thereto. A seal 464 is sealingly engaged with both the interface mechanism 436 and the head 432. Adjacent the interface mechanism 436 is a filtration media 438, and an endcap 440 coupled thereto, in a slidable arrangement with filter housing 444. Positioned between the endcap 440 and an inner surface of the filter housing 444 is a spring 442. It shall be appreciated that any and all of the various components shown with respect to water filter cartridge 430, such as endcap 440, interface mechanism 436, spring 442, seal 464, filtration media 438, and head 432, may be substituted with corresponding components in alternate configurations as described throughout this disclosure. Additionally or alternatively, any of the aforementioned components such as endcap 440, interface mechanism 436, spring 442, seal 464, filtration media 438, and head 432 may be omitted from water filter cartridge 430. For example, the user may, after removing the filtration media 438 from the water filter cartridge 430, introduce cleaning fluid and/or a liquid solution (e.g., including the cleaning media) from a source by placing the source in fluid communication with the manifold of the appliance. In some embodiments, the water filter cartridge 430 and/or a similar device may be the source for cleaning fluid, liquid solution, cleaning media, and/or the like. Accordingly, the water filter cartridge 430 may be provided without filtration media 438 and/or endcap 440, and/or interface mechanism 436, and/or spring 442, and/or seal 464.

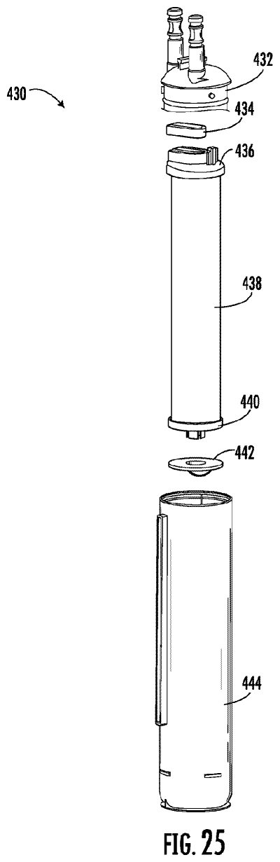

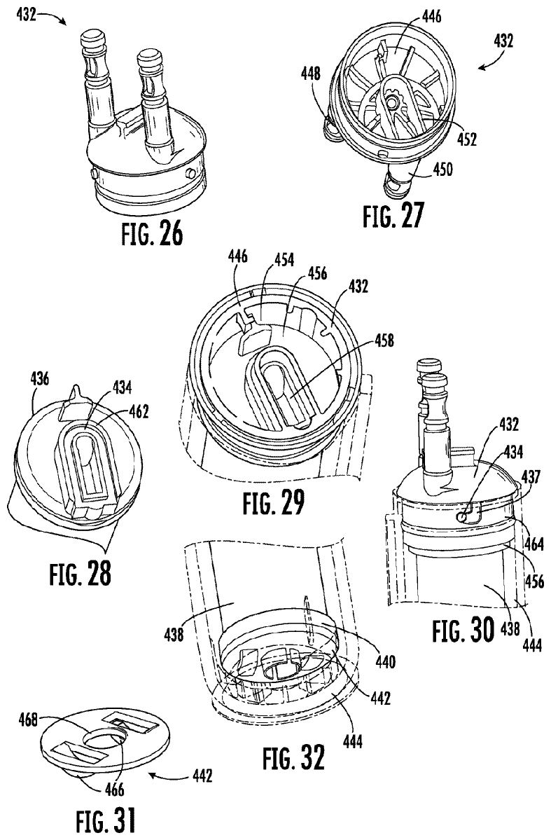

FIGS. 26-27 illustrate perspective views of a head 432 of water filter cartridge 430, in accordance with an embodiment of the invention. As shown in FIG. 27, head 432 may include a fluid inlet 448 and fluid outlet 450, configured to be in fluid communication with the cavity of the filter housing in order to transport a fluid such as water. The fluid inlet 448 and the fluid outlet 450 may be coupled to a head 432, which may, in some embodiments, be separable from the filter housing. Head 432 may also comprise one or more positioning features 446, structured to matingly engage with one or more corresponding stopper(s) 454 on the interface mechanism 436 as will be described herein with respect to FIG. 29.

Head 432 may also include a seal protrusion 452 extending from the internal cavity of head 432 towards the interface mechanism 436 when positioned in the water filter cartridge 430. The seal protrusion 452 is structured to sealingly engage with a seal 464 positioned in the interface mechanism 436, such as to isolate the inflow and/or outflow of fluid and prevent contamination of the inflow of fluid (e.g., unfiltered liquid) with the outflow of fluid (e.g., filtered liquid), and direct the inflow of fluid to the filtration media 438.

Referring now to FIGS. 28-30, the seal 464 may be positioned within a seal cavity 462 of the interface mechanism 436. The seal 464 may be fabricated of various types of rubber, composite, foam, or any other material suitable for achieving a liquid-tight interface between the one or more components of interface mechanism 436 and/or head 432. Liquid-tight sealing may occur as a result of compression and/or deformation of seal 464 against the adjacent surfaces of interface mechanism 436 and/or head 432 when forces in the longitudinal direction of the water filter cartridge, from the assembling of the interface mechanism 436 and/or head 432 with seal 464, induce material disposition between the seal 464 and the adjacent surfaces of interface mechanism 436 and/or head 432.

When assembled, a first end of interface mechanism 436 is positioned adjacent and coupled to the filtration media 438, while the second end of the interface mechanism 436 is positioned adjacent and coupled to the head 432. The interface mechanism 436 may include a stopper 454, which is a protrusion extending in the axial direction from the interface mechanism 436 towards the head 432 when in the assembled configuration. The stopper 454 is a material barrier which positions the interface mechanism 436 in the proper orientation relative to the head 432, by providing a corresponding positioning feature 446 on the head 432. In some embodiments, the positioning feature 446 and/or the stopper 454 may comprise a snapping or locking feature to prevent the unintended separation of the interface mechanism 436 from the head 432. As illustrated in FIG. 29, the interface mechanism 436 may also include aperture 458, the aperture 458 structured to direct incoming and/or outgoing liquid to or from the filtration media 438.

As illustrated in FIG. 30, head 432 may also include one or more protuberances 434, the protuberances 434 extending radially outward from the outer surface of head 432, and structured to matingly engage with slots 436 of the filter housing 444. The slots 436 are configured to receive protuberances 434, such that the head 432 is assembled by placing it in the longitudinal direction relative to the filter housing 444, pressing the head 432 downwards to sealingly engage the seal 464, then twisting the head 432 relative to the filter housing 444 to secure the head 432 to the filter housing 444. It shall be appreciated that in some embodiments, head 432 may also include seal 464 on the outer circumference of head 432, as previously described with respect to at least FIGS. 1-2.

FIG. 31 illustrates a perspective view of a spring 442. As shown in FIGS. 31-32, in some embodiments the spring 442 may be positioned adjacent the endcap 440 and structured to be positioned between the endcap 440 and the filter housing 444, such that the spring 442 is coupled to both the filter housing 444 and the endcap 440. The spring 442 may include an aperture 468, configured to receive a corresponding protuberance from the endcap 440. Accordingly, when assembled, the protuberance from endcap 440 extends through the aperture 468 of the spring to be coupled to a corresponding aperture in the filter housing 444. The spring 442 may include one or more deflection tabs 466 which extend from one face of the spring 442, and are structured be placed adjacent a corresponding surface of the filter housing 444 and deflect (e.g., bend) when force is applied in the axial direction to the components inside the water filter cartridge 430. In this way, when force is applied to head 432 to facilitate the assembly of the water filter cartridge 430, force is transferred through the filtration media 438 to the spring 442, which causes deflection tabs 466 to deflect and prevent damage to the filtration media 438 from occurring. Furthermore, after assembly of the water filter cartridge 430, the deflection tabs 466 and the spring 442 apply a force in an axial direction toward the head 432 to press the interface mechanism 436 and the seal 464 against the head 432, thereby facilitating the formation of a liquid-tight seal via compression and/or deformation of seal 464 against the seal protrusion 452 of the head 432. In some embodiments, filter housing 444 may include recesses, channels, or apertures structured to receive the deflection tabs 466.

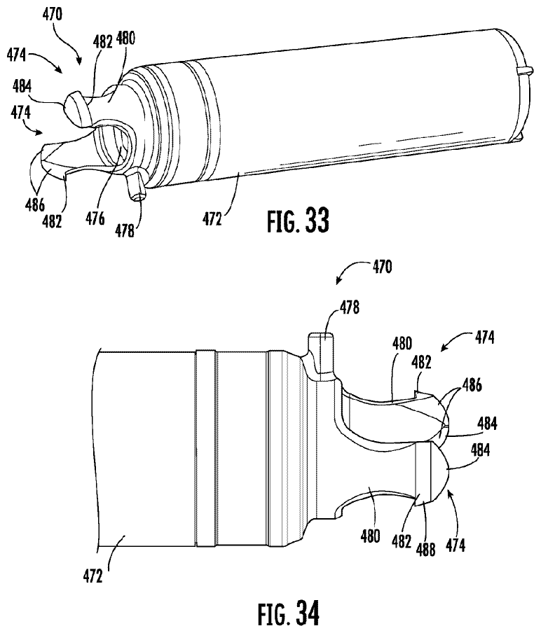

FIGS. 33-36 illustrate perspective views and a front view of a head, in accordance with an embodiment of the invention. As shown in FIG. 33, the filter cartridge may include a fluid inlet and outlet 476 as well as an head 470, which may be formed into the filter body 472 and/or attached to the filter body 472 as shown in FIG. 33. In some embodiments, the fluid inlet and outlet 476 may be formed in a central portion of the first end of the filter body 472, and the head 470 may be formed into the filter body 472 and/or attached to the filter body 472 at a peripheral portion of the first end of the filter body 472. In use, water may pass through the fluid inlet into the filter body 472, and pass through the fluid outlet to the appliance.

As shown in FIG. 33, the head 470 may include a key 478 and two displaceable latch features, depicted in FIG. 33 as flexible prongs 474. The displaceable latch features may, in some embodiments, have different features as compared to the flexible prongs 474 (e.g., rotating elements, latches, blocks, and/or the like). In some embodiments, the key 478 may extend radially outward from the head 470 (e.g., from an outer surface of the head 470 and/or the like). In some embodiments, the flexible prongs 474 may extend from the head 470 in a substantially longitudinal direction. Accordingly, in some embodiments, the flexible prongs 474 may define a fixed end and a free end, and extend in a substantially longitudinal direction therebetween. In some embodiments, the fixed end of the flexible prongs 474 may be positioned on a peripheral outer surface of the head 470. In other embodiments, the fixed end of the flexible prongs 474 may be positioned on a top surface of the head 470. In some embodiments, the flexible prongs 474 may be diametrically opposed relative the outer surface of the head 470.

In some embodiments, a latch surface is able to engage a sidewall of the channel of a corresponding manifold (not depicted in FIGS. 33-34) in a latched condition, and to be disengaged from the sidewall of the channel in a different position to allow the displaceable latch features to be removed from the receiver portion of the manifold. In some embodiments, and as described herein, once the first and second flexible prongs 474 are received in corresponding receptacles of a manifold, rotation of the filter cartridge in a first direction is prevented, while rotation of the filter cartridge in a second direction is permitted.

FIG. 34 illustrates a close-up, side view of the head 470 of the filter cartridge, in accordance with an embodiment of the invention. As shown in FIG. 34, each of the flexible prongs 474 may define neck portions 480 extending from a base. The neck portions 480 may be shaped to be more narrow at the portions defining the free ends of the flexible prongs 474 (referred to as the head portions 484) while being wider at the portions defining the fixed ends of the flexible prongs 474. The neck portions 480 may extend substantially parallel to the longitudinal axis in a direction opposite the insertion direction and a head portion at an end of the neck portion.

The free ends of the flexible prongs 474 may also include head portions 484, which are rounded to be received into receptacles of the manifold to be locked in place. The outer edge of the head portions 484 may extend radially outward beyond the neck portion, which may be received by a space (receptacles) in the manifold after insertion. Additionally, or alternatively, the head portions 484, as well as chamfers 486 may serve to align and orient the flexible prongs 474 during the installation and removal processes. This design feature enables a margin of imprecision in initial flexible prong placement, as the interfaces between flexible prongs 474 and the manifold are guided, thus allowing subsequent correction to achieve the intended precise positioning.

Additionally, or alternatively, and as also shown in FIG. 34, the free ends of the flexible prongs 474, may include latch features 482 which provide a flared edge. The edge of the head portion may extend radially outward from the neck portion, which may permit the latch features 482 to sit in the receptacles and prevent movement of the filter cartridge in a direction opposite the insertion direction.

As shown in FIGS. 33 and 34, the key 478 may be shaped as an extruded cylinder, and, as described further herein, the key 478 may interact with a keyway in a tube and/or guide of the filter cartridge manifold 494. In some embodiments, the key 478 may have a cylindrical-shape with a beveled and/or curved outer edge where the sidewalls of the cylinder meet the circular end of the key 478 (e.g., the upward-facing surface in the orientation shown in FIG. 34).

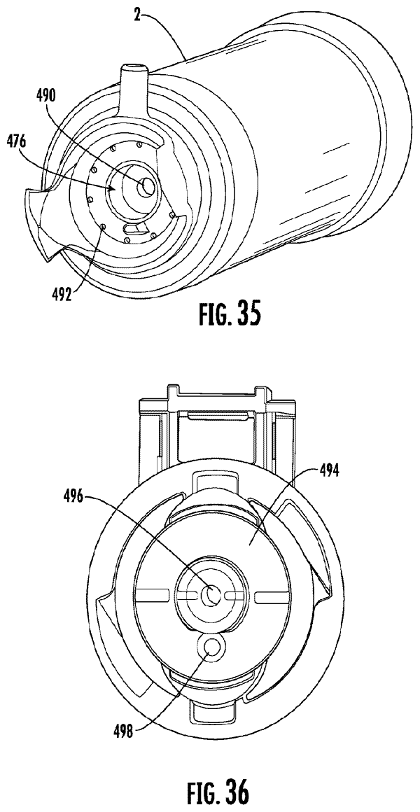

Referring now to FIGS. 35 and 36, the head 470 interfaces with the filtration media 12 in a manner similar to that described herein with respect to FIGS. 1-3C. For example, in some embodiments, an interface mechanism 16 such as that which is illustrated in FIGS. 3A and 3B may be configured to be positioned adjacent the first end of the filtration media 12 with a first protuberance 18 in fluid communication the head 470. However, rather than having a fluid inlet and outlet extending outward from the head as shown in FIGS. 1-3C, the fluid inlet and outlet 476 may include a central opening 490 in the head for receiving water from the manifold 494 and a plurality of holes 492 positioned in a ring-shape radially offset from the central opening 490 for providing filtered water exiting the filtration media 12 through the interface mechanism 16 to the manifold.

After the water filter cartridge 100 has been positioned within a manifold 494 of an appliance, the fluid inlet and outlet 476 may be in fluid communication with the manifold 494. Unfiltered fluid from the manifold 494 passes through the manifold hole 496, and through central opening 490 of the head 470. The central opening 490 is in fluid communication with at least a portion of the cavity within the filter housing 2, which contains the filtration media 12. The fluid may then be filtered through the filtration media 12. The filtered fluid (or other fluid contents within the filter housing), then exits the water filter cartridge 100 through the interface mechanism 16, the plurality of holes 492 in the head 470, and is then directed into the bottom hole 498 of the manifold.

In some embodiments, similar to the embodiment shown in FIG. 2, adjacent an end of filtration media 12 opposite the interface mechanism 16 may be an endcap 20, comprising a plug 34 extending from the first face of the endcap 20 towards the filtration media 12, the outer surface of the plug 34 structured to matingly engage with a corresponding aperture of the filtration media 12.

### INCORPORATION BY REFERENCE

To supplement the present disclosure, each of the following patents, patent publications, and patent applications, is incorporated herein by reference in its entirety: U.S. Pat. Nos. U.S. Pat. No. 10,022,658B2; U.S. Pat. No. 10,010,820B1; U.S. Pat. No. 9,937,451B2; U.S. Pat. No. 8,950,052B2; U.S. Pat. No. 8,845,896B2; U.S. Pat. No. 8,591,736B2; U.S. Pat. No. 8,413,818B1; U.S. Pat. No. 8,356,716B1; U.S. Pat. No. 7,610,932B2; U.S. Pat. No. 7,147,773B2; U.S. Pat. No. 7,000,894B2; USRE46554E1; U.S. Pat. No. 7,799,220B2; U.S. Pat. No. 8,182,699B2; U.S. Pat. No. 9,872,584B2; USD772379S1; USD472299S1; U.S. Pat. No. 9,687,762B2; U.S. Pat. No. 9,345,995B2; U.S. Pat. Nos. 5,907,958A; 9,366,388B2; 10,603,612B2; 10,913,020B2; 10,905,989B2; 10,272,370B2; 9,242,195B2; 9,027,361B2; 8,955,349B2; 10,946,319B2; 9,993,757B2; 10,737,206B2; USD735294S1; U.S. Pat. Nos. 9,901,854B1; 7,823,407B2; 9,494,362B2; 9,487,414B2; 8,496,823B2; 9,320,993B2; 10,967,313B2; U.S. Published Application Nos. US20120211412A1; US20180056216A1; US20180304181A1; US20210178297A1; US20150157967A1; US20100000919A1; US20210299600A1; US20200139280A1; US20150258476A1; U.S. patent application Ser. Nos. 29/786,024; 29/786,025; 29/786,026; 29/786,027; 17/333,124; and U.S. Provisional Application Ser. No. 63/423,976.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments may be configured without departing from the scope and spirit of the invention. Therefore, it is to be understood that, within the scope of the appended claims, the invention may be practiced other than as specifically described herein.

1. A water filter cartridge, comprising:
a filter housing defining a cavity;
a fluid inlet and a fluid outlet positioned on the filter housing and in fluid communication with the cavity; and
a removable filtration media positioned within the cavity;
wherein the filter housing is configured to provide access to the removable filtration media.

2-6. (canceled)

7. The water filter cartridge of claim 1, wherein the filter housing comprises a removable portion configured to be removed from another portion of the filter housing to provide the access to the removable filtration media.

8. The water filter cartridge of claim 7, wherein the removable portion is a cap configured to engage the filter housing and seal the cavity, wherein the cap is configured to be manually removable from the other portion of the filter housing to provide the access to the removable filtration media.

9. The water filter cartridge of claim 8, wherein the cap is configured to be manually replaced to seal the cavity.

10. The water filter cartridge of claim 7, wherein the removable portion is a filter head comprising the fluid inlet and the fluid outlet, wherein the filter head is configured to be manually removable from the other portion of the filter housing to provide the access to the removable filtration media.

11. The water filter cartridge of claim 7, wherein the removable portion is a filter head comprising the fluid inlet and the fluid outlet, and wherein the filter head is fixed to the removable filtration media such that when the filter head is removed from the other portion of the filter housing the removable filtration media is removed from the filter housing as a result.

12. The water filter cartridge of claim 11, wherein the filter head comprises:
a key extending radially outward from the filter head; and
at least one displaceable latch feature extending longitudinally from the filter head.

13. The water filter cartridge of claim 12, wherein after insertion of the water filter cartridge into a manifold comprising at least one receptacle, a stop element of the at least one receptacle interacts with the at least one displaceable latch feature to prevent rotation of the water filter cartridge in a first direction; and
after insertion of the water filter cartridge into the manifold, a curved transition surface of the manifold interacts with the at least one displaceable latch feature to permit rotation of the water filter cartridge in a second direction.

14-17. (canceled)

18. A filtration media unit, comprising:
filtration media; and
an interface mechanism for providing fluid communication between:
a fluid inlet of a filter cartridge and the filtration media; and
the filtration media and a fluid outlet of the filter cartridge;
wherein the interface mechanism is configured to be detachable from the filter cartridge.

19. The filtration media unit of claim 18, wherein the filtration media has a first end, a second end, and a longitudinal axis, and wherein the interface mechanism is positioned on the first end of the filtration media.

20. The filtration media unit of claim 18, wherein the interface mechanism comprises a cross-over passage to provide the fluid communication between the filtration media and the fluid outlet of the filter cartridge.

21. The filtration media unit of claim 18, wherein the interface mechanism comprises:
a key extending radially outward from the interface mechanism; and
at least one displaceable latch feature extending longitudinally from the interface mechanism.

22. The filtration media unit of claim 21, wherein after insertion of the filtration media unit into a manifold comprising at least one receptacle, a stop element of the at least one receptacle interacts with the at least one displaceable latch feature to prevent rotation of the filtration media unit in a first direction; and
after insertion of the filtration media unit into the manifold, a curved transition surface of the manifold interacts with the at least one displaceable latch feature to permit rotation of the filtration media unit in a second direction.

23. The filtration media unit of claim 21, wherein during insertion of the filtration media unit into a manifold, a latch feature of the at least one displaceable latch feature interacts with a curved interior surface of the manifold, prior to being received by at least one receptacle of the manifold, to force the at least one displaceable latch feature to flex radially inward as a result.

24. The filtration media unit of claim 22, wherein during insertion of the filtration media unit into the manifold, a latch feature of the at least one displaceable latch feature interacts with a curved interior surface of the manifold, prior to being received by the at least one receptacle of the manifold, to force the at least one displaceable latch feature to flex radially inward as a result.

25. The filtration media unit of claim 21, wherein during removal of the filtration media unit from a manifold, and counterclockwise rotation of the filtration media unit in the manifold, the at least one displaceable latch feature interacts with a curved transition surface of at least one receptacle of the manifold to force the at least one displaceable latch feature to flex radially inward.

26. The filtration media unit of claim 22, wherein during removal of the filtration media unit from the manifold, and counterclockwise rotation of the filtration media unit in the manifold, the at least one displaceable latch feature interacts with the curved transition surface of the at least one receptacle of the manifold to force the at least one displaceable latch feature to flex radially inward.

27. A method of replacing filtration media within a water filter cartridge, the method comprising:
providing a water filter cartridge, comprising:
a filter housing defining a cavity;
a fluid inlet and a fluid outlet positioned on the filter housing and in fluid communication with the cavity; and
a first removable filtration media positioned within the cavity;
wherein the filter housing is configured to provide access to the first removable filtration media;
manipulating the filter housing to obtain the access to the first removable filtration media;
removing the first removable filtration media from the cavity;
inserting a second removable filtration media into the cavity; and
manipulating the filter housing to seal the cavity.

28-45. (canceled)

46. The method of claim 27, wherein the filter housing comprises a removable portion configured to be removed from another portion of the filter housing to provide the access to the first removable filtration media, and wherein the method comprises:
when manipulating the filter housing to obtain the access to the first removable filtration media, manually manipulating the removable portion of the filter housing to provide the access to the removable filtration media; and
when manipulating the filter housing to seal the cavity, manually manipulating the removable portion of the filter housing to seal the cavity.

47. The method of claim 27, wherein the filter housing comprises a displaceable latch feature extending longitudinally from the filter housing, and wherein the method comprises inserting the water filter cartridge into an appliance to engage a manifold of the appliance with the displaceable latch feature.
